(19) United States
(12) Patent Application Publication
(10) Pub. No.: US 2024/0172798 A1
(43) Pub. Date: May 30, 2024

(54) DIELECTRICALLY HEATED AEROSOL-GENERATING SYSTEM WITH SEGMENTED HEATER

(71) Applicant: Philip Morris Products S.A., Neuchatel (CH)

(72) Inventors: Ana Isabel GONZALEZ FLOREZ, St-Sulpice (CH); Roberto MANCINI, Bofflens (CH); Enrico TURRINI, Neuchatel (CH)

(73) Assignee: Philip Morris Products S.A., Neuchatel (CH)

(21) Appl. No.: 18/547,534

(22) PCT Filed: Mar. 2, 2022
(86) PCT No.: PCT/EP2022/055309

§ 371 Date: Aug. 23, 2023

(30) Foreign Application Priority Data
Mar. 2, 2021 (EP) 21160318.8

(51) Int. Cl. A24F 40/46; A24D 1/20; A24F 1/30; A24F 40/20; A24F 40/53; A24F 40/57; H05B 6/50; H05B 6/62

(52) U.S. Cl. CPC A24F 40/46; A24D 1/20; A24F 1/30; A24F 40/20; A24F 40/53; A24F 40/57; H05B 6/50; H05B 6/62

(57) ABSTRACT

A dielectrically heatable aerosol-generating system is provided, including: an aerosol-forming substrate; a plurality of pairs of electrodes, each pair of electrodes including a first electrode spaced apart from a second electrode; and an aerosol-generating device including a controller configured to connect to each pair of electrodes, in which each pair of electrodes forms a capacitor with a portion of the aerosol-forming substrate, and in which the controller is further configured to supply an alternating voltage to the plurality of pairs of electrodes for dielectrically heating the aerosol-forming substrate. An aerosol-generating article for a dielectrically heated aerosol-generating system is also provided.

The present disclosure relates to an aerosol-generating system, and in particular a dielectrically heated aerosol-generating system. The present disclosure also relates to an aerosol-generating device for use in an aerosol-generating system and an aerosol-generating article for use in an aerosol-generating system. The present disclosure further relates to a method of dielectrically heating an aerosol-forming substrate.

Known electrically operated aerosol-generating systems typically heat an aerosol-forming substrate by one or more of: conduction of heat from a heating element to an aerosol-forming substrate, radiation of heat from a heating element to an aerosol-forming substrate or drawing heated air through an aerosol-forming substrate. Most commonly, heating is achieved by passing an electrical current through an electrically resistive heating element, giving rise to Joule heating of the heating element. Inductive heating systems have also been proposed, in which Joule heating occurs as a result of eddy currents induced in a susceptor heating element.

A problem with these heating mechanisms is that they may give rise to non-uniform heating of the aerosol-forming substrate. The portion of the aerosol-forming substrate closest to the heating element is heated more quickly or to a higher temperature than portions of the aerosol-forming substrate more remote from the heating element.

Systems that dielectrically heat an aerosol-forming substrate have been proposed, which advantageously provide uniform heating of the aerosol-forming substrate. However, it would be desirable to provide a system that dielectrically heats an aerosol-forming substrate in a manner that allows for greater heating control, while still being realisable in a compact system.

In this disclosure, there is provided a dielectrically heated aerosol-generating system. The aerosol-generating system may comprise an aerosol-forming substrate. The aerosol-generating system may comprise a plurality of pairs of electrodes, each pair of electrodes comprising a first electrode spaced apart from a second electrode. The aerosol-generating system may comprise an aerosol-generating device. The aerosol-generating device may comprise a controller configured to connect to each pair of electrodes. Each pair of electrodes may form a capacitor with a portion of the aerosol-forming substrate. The controller may be configured to supply an alternating voltage to the plurality of pairs of electrodes for dielectrically heating the aerosol-forming substrate.

Such an aerosol-generating system is configured to give rise to dielectric heating of the aerosol-forming substrate due to the alternating electromagnetic field generated between the first electrode and the second electrode of each pair of electrodes on supply of the alternating voltage to the first electrode and the second electrode of each pair of electrodes. Dielectric heating can be uniform within a volume of aerosol-forming substrate, without the creation of hot spots. In particular, dielectric heating reduces the likelihood of combustion of aerosol-forming substrate in contact with the first electrode and the second electrode, of each pair of electrodes, compared to a conventional heating that transfers heat to the aerosol-forming substrate via conduction.

Advantageously, an aerosol-generating system comprising a plurality of pairs of electrodes may provide improved control of the dielectric heating of an aerosol-forming substrate. This is because different portions of the aerosol-forming substrate may be heated differently, either at different times, or to different temperatures. Each pair of electrodes may be supplied with an appropriate alternating voltage to generate a desired aerosol from that portion of the aerosol-forming substrate.

The portions of aerosol-forming substrate disposed between each pair of electrodes may have different characteristics. This may enable the characteristics of the aerosol generated by the aerosol-generating system to vary over a user experience. Advantageously, this may provide an optimal experience for a user. As an example, each different portion of aerosol-forming substrate may have a different thickness in order to produce a desired volume of aerosol, or rate of aerosol generation of aerosol, at different stages of a usage session of the aerosol-generating system. In a further example, each different portion of aerosol-forming substrate may have a different composition that generates an aerosol having a different flavour in order to produce a variable aerosol flavour at different stages of a usage session of the aerosol-generating system. Providing an aerosol-generating system with a plurality of pairs of electrodes permits selectively controlled heating of different portions of the aerosol-forming substrate to obtain the desired aerosol characteristics at each stage of the experience for a user. This control may, for example, be achieved by varying the separation distance between the first electrode and the second electrode of each pair of electrodes, by varying the geometry of the first electrode and the second electrode of each pair of electrodes, or by varying the magnitude or the frequency of the alternating voltage supplied to each pair of electrodes.

In the system of this disclosure, the plurality of pairs of electrodes may be arranged in any suitable manner. In some embodiments, the aerosol-generating device comprises the plurality of pairs of electrodes. In some embodiments, the aerosol-generating system comprises an aerosol-generating article comprising the aerosol-forming substrate, and the aerosol-generating article further comprises the plurality of pairs of electrodes. In some embodiments, the aerosol-generating system comprises an aerosol-generating article comprising the aerosol-forming substrate, the aerosol-generating device comprises at least one electrode of the plurality of pairs of electrodes, and the aerosol-generating article comprises at least one electrode of the plurality of pairs of electrodes.

As used herein, the term “aerosol-forming substrate” relates to a substrate capable of releasing volatile compounds that can form an aerosol. Such volatile compounds may be released by heating the aerosol-forming substrate. An aerosol-forming substrate is typically part of an aerosol-generating article.

As used herein, the term “aerosol-generating article” refers to an article comprising an aerosol-forming substrate that is capable of releasing volatile compounds that can form an aerosol. For example, an aerosol-generating article may be an article that generates an aerosol that is directly inhalable by the user drawing or puffing on a mouthpiece. An aerosol-generating article may be disposable. An article comprising an aerosol-forming substrate comprising tobacco may be referred to as a tobacco stick.

As used herein, the term “aerosol-generating device” refers to a device that interacts with an aerosol-forming substrate to generate an aerosol. An aerosol-generating article is separate from and configured for combination with an aerosol-generating device for heating the aerosol-generating article.

As used herein, the term “aerosol-generating system” refers to the combination of an aerosol-generating device with an aerosol-forming substrate. In the aerosol-generating system, the aerosol-forming substrate and the aerosol-generating device cooperate to generate an aerosol.

The aerosol-generating system comprises an aerosol-generating device.

In this disclosure, there is also provided a dielectrically heated aerosol-generating device. The aerosol-generating device comprises a plurality of pairs of electrodes, each pair of electrodes comprising a first electrode spaced apart from a second electrode. The aerosol-generating device further comprises a controller connected to each pair of electrodes. The device is configured to receive an aerosol-forming substrate. Each pair of electrodes forms a capacitor with at least a portion of the aerosol-forming substrate. The controller is configured to supply an alternating voltage to the plurality of pairs of electrodes for dielectrically heating the aerosol-forming substrate.

The aerosol-generating system comprises an aerosol-forming substrate. In some preferred embodiments, the aerosol-generating system comprises an aerosol-generating article comprising the aerosol-forming substrate. The aerosol-generating device may be configured to receive the aerosol-generating article. The aerosol-generating device may comprise an article cavity configured to receive at least a portion of the aerosol-generating article.

In this disclosure, there is also provided an aerosol-generating article for a dielectrically heated aerosol-generating system. The aerosol-generating article comprises an aerosol-forming substrate. The aerosol-generating article further comprise a plurality of pairs of electrodes, each pair of electrodes comprising a first electrode spaced apart from a second electrode. Each pair of electrodes forms a capacitor with at least a portion of the aerosol-forming substrate. Preferably, at least a portion of the aerosol-forming substrate is arranged between the first electrode and the second electrode of each of the plurality of pairs of electrodes.

In aerosol-generating systems in which an aerosol-generating article is provided, and the aerosol-generating article comprises at least one electrode of the plurality of electrodes, the aerosol-generating device may comprise at least one electrical contact. The electrical contact of the aerosol-generating device may be arranged to electrically connect with the electrode of the aerosol-generating article. Where the aerosol-generating article comprises a plurality of electrodes, the aerosol-generating device may comprise a plurality of electrical contacts. The electrical contacts of the aerosol-generating device may be arranged to electrically connect with the electrodes of the aerosol-generating article when the aerosol-generating article is received by the aerosol-generating device.

In aerosol-generating systems in which an aerosol-generating article is provided, and the aerosol-generating device comprises an article cavity configured to receive at least a portion of the aerosol-generating article, at least a portion of the aerosol-forming substrate may be located in the article cavity when at least a portion of the article is received in the cavity. The plurality of electrodes may also be located in the article cavity when at least a portion of the article is received in the article cavity. At least a portion of the aerosol-forming substrate may be received between each pair of electrodes when at least a portion of the article is received in the article cavity. Where the aerosol-generating article comprises at least one electrode, and the aerosol-generating device comprises at least one electrical contact configured to electrically connect to the electrode of the aerosol-generating article, the at least one electrical contact may be arranged in the article cavity.

Where the aerosol-generating article comprises a pair of electrodes, the first electrode and the second electrode of the pair of electrodes may be arranged at opposite sides of the article. Where the aerosol-generating device comprises a pair of electrodes, and an article cavity, the first electrode and the second electrode of the pair of electrodes may be arranged at opposite sides of the article cavity.

Each pair of electrodes forms a capacitor. Each capacitor may comprise the first electrode and the second electrode. Each capacitor may comprise the first electrode, the second electrode and a portion of the aerosol-forming substrate. The aerosol-forming substrate may be arranged between the first electrode and the second electrode. In some embodiments, only the aerosol-forming substrate is arranged between the first electrode and the second electrode. In other words, the aerosol-forming substrate may be arranged directly between the first electrode and the second electrode without any other intervening components. In some embodiments, the aerosol-forming substrate and one or more other components are arranged between the first electrode and the second electrode. In other words, the aerosol-forming substrate may be indirectly arranged between the first and second electrode, with one or more additional, intervening components arranged between at least one of the electrodes and the aerosol-forming substrate. For example, in some embodiments, the aerosol-generating system may comprise an aerosol-generating article comprising the aerosol-forming substrate and a wrapper circumscribing the aerosol-forming substrate. In these embodiments, at least a portion of the aerosol-generating article may be arranged between the first electrode and the second electrode. In these embodiments, at least a portion of the aerosol-forming substrate and at least a portion of the wrapper may be arranged between the first electrode and the second electrode.

The aerosol-forming substrate may comprise one or more dielectric materials. The aerosol-forming substrate may be a dielectric material. The components arranged between the first electrode and the second electrode may comprise dielectric materials. The components arranged between the first electrode and the second electrode may be dielectric materials.

The aerosol-generating device comprises a controller configured to connect to each pair of electrodes. The controller is configured to supply the alternating voltage to the plurality of pairs of electrodes.

The controller may be configured to control the supply of the alternating voltage to the plurality of pairs of electrodes. In some embodiments, the controller may be configured to selectively control the supply of the alternating voltage to each pair of electrodes. In other words, the supply of the alternating voltage to a first pair of electrodes may be independently controlled from the supply of the alternating voltage to other pairs of electrodes. Selective control of the supply of the alternating voltage to each pair of electrodes provides improved control over the heating of the aerosol-forming substrate. For example, different portions of aerosol-forming substrate can be heated at different times, for different durations of time, and to different temperatures, during a usage session of the system.

In some embodiments, the controller may be configured to supply the alternating voltage to one pair of electrodes at a time. The aerosol-generating device may be provided with a user input to allow a user to control when the alternating voltage is supplied to each pair of electrodes. In some embodiments, the controller may be configured to selectively supply the alternating voltage to each pair of electrodes in a sequence. For example, the controller may initially supply the alternating voltage to a first pair of electrodes only, and subsequently supply the alternating voltage to a second pair of electrodes.

In some embodiments, the controller is configured to selectively supply the alternating voltage to each pair of electrodes in a sequence, wherein the controller supplies the alternating voltage to a first pair of electrodes, and the controller subsequently supplies the alternating voltage to a second pair of electrodes after a condition is met. The second pair of electrodes may be adjacent the first pair of electrodes. The second pair of electrodes may be located towards an opposite end of the aerosol-forming substrate to the first pair of electrodes. Supplying the alternating voltage to each pair of electrodes in a sequence may advantageously enable the characteristics of the generated aerosol to be varied over time in a controlled manner.

In some embodiments, the sequence may be a predetermined sequence. The controller may comprise a memory storing the predetermined sequence. A predetermined sequence may provide a consistent aerosol generation experience for a user.

In some embodiments, the controller may be configured to determine a sequence of supply of the alternating voltage to each pair of electrodes. A controller that can determine the sequence of supply of the alternating voltage to each pair of electrodes may advantageously enable a customisable aerosol generation experience for a user.

In some embodiments, the controller may be configured to determine a sequence of supply of the alternating voltage to each pair of electrodes based on a sensed parameter. In some embodiments, the sequence may be determined based on at least one of: a temperature of one or more of the plurality of pairs of electrodes, a temperature of the aerosol-forming substrate, a temperature adjacent to the aerosol-forming substrate, an activation of a puff sensor, and a duration of supply of the alternating voltage to one or more of the plurality of pairs of electrodes.

In some embodiments, the controller may be configured to monitor which of the plurality of pairs of electrodes has received the supply of the alternating voltage. The controller may further comprise a memory configured to store which of the plurality of pairs of electrodes has received the supply of the alternating voltage. In some embodiments, the memory may additionally be configured to store one or more of: a temperature of the pair of electrodes at the start of receiving the supply of the alternating voltage, a temperature of the pair of electrodes at the end of receiving received the supply of the alternating voltage, a temperature of a portion of aerosol-forming substrate disposed between the pair of electrodes at the start of receiving the supply of the alternating voltage, a temperature of a portion of aerosol-forming substrate disposed between the pair of electrodes at the end of receiving the supply of the alternating voltage and a duration of supply of the alternating voltage to the pair of electrodes. The monitoring and storing of these parameters may allow the aerosol-generating system to determine an optimal heating profile for aerosol generation from the aerosol-forming substrate.

The aerosol-generating system comprises a plurality of pairs of electrodes. The plurality of pairs of electrodes may comprise any suitable number of pairs of electrodes. A low number of pairs of electrodes may simplify manufacturing cost and complexity, by decreasing the overall complexity of the system. A larger number of pairs of electrodes may increase the degree of control over the heating of the aerosol-forming substrate that is provided by the aerosol-generating system. In some embodiments, the plurality of pairs of electrodes may comprise between 2 and 20 pairs of electrodes. The plurality of pairs of electrodes may comprise between 2 and 15 pairs of electrodes, or between 2 and 12 pairs of electrodes, or between 5 and 10 pairs of electrodes. In some preferred embodiments, the plurality of pairs of electrodes may comprise between 2 and 6 pairs of electrodes.

A system comprising between 2 and 6 pairs of electrodes has been found to provide a satisfactory compromise between complexity of the system and the degree of heating control provided.

In some embodiments, the plurality of pairs of electrodes may comprise 2 pairs of electrodes, 3 pairs of electrodes, 4 pairs of electrodes, 5 pairs of electrodes, 6 pairs of electrodes, 7 pairs of electrodes, 8 pairs of electrodes, 9 pairs of electrodes, or 10 pairs of electrodes. In particularly preferred embodiments, the plurality of pairs of electrodes may comprise 9 pairs of electrodes.

In some embodiments, the first electrodes of the plurality of pairs of electrodes may form a first array of electrodes, each electrode in the first array of electrodes being spaced apart by an electrode spacing distance. The second electrodes of the plurality of pairs of electrodes may form a second array of electrodes, each electrode in the second array of electrodes being spaced apart by the electrode spacing distance. In some embodiments, the electrode spacing distance may be between about 0.1 millimetres and about 2 millimetres. The electrode spacing distance may be between about 0.5 millimetres and about 1.5 millimetres. In some particularly preferred embodiments, the electrode spacing distance may be about 1 millimetre.

If the electrode spacing distance is too large, then unacceptable heat losses may occur between adjacent pairs of electrodes. However, if the electrode spacing is too small then the electromagnetic fields between each pair of electrodes may interfere with one another. An electrode spacing distance of between about 0.1 millimetres and about 2 millimetres has been found to provide a satisfactory compromise between these two factors.

In some embodiments, a first electrically insulative material may be arranged between adjacent electrodes in the first electrode array. In some embodiments, a second electrically insulative material may be arranged between adjacent electrodes in the second electrode array. In some embodiments, at least one of the first electrically insulative material and the second electrically insulative material comprises polyetheretherketone (PEEK), polyaryletherketone (PAEK), polyphenylsulfone (PPSU) and a ceramic. In preferred embodiments, the first electrically insulative material and the second electrically insulative material are the same. Preferably, the first electrically insulative material and the second electrically insulative material have a melting temperature above the temperature required to vaporise volatile compounds from the aerosol-forming substrate. In particularly preferred embodiments, the first electrically insulative material and the second electrically insulative material have a melting point greater than about 250 degrees Celsius.

As used herein, ‘electrically conductive’ means formed from a material having a resistivity of 1×10\hat{ }−4 Ohm meter, or less. As used herein, ‘electrically insulative’ means formed from a material having a resistivity of 1×10\hat{ }−4 Ohm meter or more.

Preferably, the first electrically insulative material is a thermally insulative material. Preferably, the second electrically insulative material is a thermally insulative material. As used herein the term ‘thermally insulative’ is used to describe material having a bulk thermal conductivity of less than or equal to about 40 watts per metre Kelvin (W/(m·K)) at 23 degrees Celsius and a relative humidity of 50 percent as measured using the modified transient plane source (MTPS) method.

The first electrodes of the first array of electrodes may be arranged in any suitable arrangement. Similarly, the second electrodes of the second array of electrodes may be arranged in any suitable arrangement. In some embodiments, the electrodes of the first array of electrodes may be substantially tessellated. In some embodiments, the electrodes of the second array of electrodes may be substantially tessellated. Tessellating the arrays of electrodes may increase the fraction of aerosol-forming substrate that can be arranged directly between the pairs of electrodes, and in turn, dielectrically heated by the pairs of electrodes compared to non-tessellated arrays of electrodes. Tessellated arrays of electrodes may also reduce heat losses in the spaces between pairs of electrodes.

In some embodiments, the first electrode of each pair of electrodes may be arranged substantially parallel to the second electrode of the pair of electrodes. Where the first electrodes are arranged in a first array of electrodes, the first electrodes may be arranged on a first plane. Where the second electrodes are arranged in a second array of electrodes, the second electrodes may be arranged on a second plane. The second plane may be parallel to the first plane.

In some embodiments, the first electrode of each pair of electrodes may have a first length and the second electrode of each pair of electrodes may have a second length. The second length may be substantially the same as the first length. The first length may be between about 3 millimetres and about 50 millimetres. In some embodiments, the first length may be between about 5 millimetres and about 30 millimetres. In some embodiments, the first length may be between about 5 millimetres and about 25 millimetres. In some embodiments, the first length may be between about 5 millimetres and about 20 millimetres. For example, the first length may be about 5 millimetres, about 6 millimetres, about 7 millimetres, about 8 millimetres, about 9 millimetres, about 10 millimetres, about 11 millimetres, about 12 millimetres, about 13 millimetres, about 14 millimetres or about 15 millimetres.

The length of the electrodes, in part, determines the cross-section of the aerosol-forming substrate that is to be heated. Heating an amount of aerosol-forming substrate that is too small or too large may provide an undesirable experience to a user, for example, by producing an undesirable quantity or quality of aerosol. The length of the electrodes also determines the power required in order to develop an electromagnetic field between them. The electrode lengths provided in this disclosure allow desirable quantities and quality of aerosol are produced without excessive power consumption.

As used herein, the term ‘length’ refers to the maximum longitudinal dimension of an aerosol-generating device, a component of the aerosol-generating device, an aerosol-generating article or a component of an aerosol-generating article.

In some embodiments, the first lengths of the first electrodes of each pair of electrodes may be substantially the same. In other embodiments, the first length of one of the first electrodes of the plurality of pairs of electrodes may be different from the first length of another one of the first electrodes of the plurality of electrodes. By providing two or more electrode pairs of different sizes, different quantities of aerosol-forming substrate can be aerosolised. For example, at the start of a usage session of the aerosol-generating system, the larger electrode pairs may be used and, subsequently, towards the end of the usage session, comparatively smaller electrode pairs may be used. This may allow the quantity of aerosol produced to gradually reduce during a usage session. Alternatively, the system may be configured such that the amount of aerosol produced is configured to gradually increase during a usage session.

In some embodiments, the first electrode of each pair of electrodes may have a thickness of between about 0.02 millimetres and about 2 millimetres. Preferably, the first electrode of each pair of electrodes may have a thickness of between about 0.1 millimetres and about 1 millimetre. Most preferably, the first electrode of each pair of electrodes may have a thickness of between about 0.3 millimetres and about 0.5 millimetres. In some embodiments, the second electrode of each pair of electrodes may have a thickness of between about 0.02 millimetres and about 2 millimetres. Preferably, the second electrode of each pair of electrodes may have a thickness of between about 0.1 millimetres and about 1 millimetre. Most preferably, the second electrode of each pair of electrodes may have a thickness of between about 0.3 millimetres and about 0.5 millimetres. In preferred embodiments, the thickness of the first electrode of each pair of electrodes may be substantially the same as the thickness of the second electrode of each pair of electrodes.

When the first and second electrodes of each electrode pair are not sufficiently thick, it may be difficult to maintain alignment of the electrodes relative to one another. For example, it may be difficult to ensure the first and second electrodes of each electrode pair remain parallel if the thickness of one of the electrodes of a pair is particularly thin, and not rigid. When the first and second electrodes of each electrode pair are too thick, they may act as heatsinks and, as a consequence, lower the thermal efficiency of the system, resulting in increased power requirements, reduced power efficiency and reduced aerosol generation.

As used herein, the term ‘thickness’ refers to the maximum transverse dimension of an aerosol-generating device, a component of the aerosol-generating device, an aerosol-generating article or a component of an aerosol-generating article. A transverse dimension is a dimension measured in a direction orthogonal to a longitudinal direction, the longitudinal direction being the direction in which length is measured.

The first electrode and the second electrode of each pair of electrodes are spaced apart. The first electrode and the second electrode of each pair of electrodes may be spaced apart by a separation distance. As used herein, the term ‘separation distance’ is the minimum distance between opposing surfaces of the first electrode and the second electrode of an electrode pair. In some embodiments, the first electrode and the second electrode of each electrode pair are configured to be spaced apart by a separation distance of between about 0.1 millimetres and about 9 millimetres. In some embodiments, the separation distance may be configured to be between about 0.1 millimetres and about 6 millimetres. Preferably, the separation distance may be configured to be between about 0.1 millimetres and about 3 millimetres. The separation distance may be configured to be about 3 millimetres. In some embodiments, the separation distance may be configured to be about 0.1 millimetres, about 0.2 millimetres, about 0.3 millimetres, about 0.4 millimetres, about 0.5 millimetres, about 0.6 millimetres, about 0.7 millimetres, about 0.8 millimetres, about 0.9 millimetres, about 1 millimetres, about 2 millimetres, about 3 millimetres, about 4 millimetres, about 5 millimetres, about 6 millimetres, about 7 millimetres, about 8 millimetres or about 9 millimetres.

In some embodiments, the separation distance is dependent on the type of aerosol-forming substrates configured for use with the aerosol-generating system.

In embodiments for use with aerosol-forming substrates that are shisha substrates, which are described in more detail below, the first electrode of each electrode pair and the second electrode of each electrode pair are configured to be spaced apart by a separation distance of between about 2 millimetres and about 9 millimetres. In some embodiments, the separation distance may be configured to be between about 2 millimetres and about 6 millimetres. Preferably, the separation distance may be configured to be between about 2 millimetres and about 4 millimetres. More preferably, the separation distance may be configured to be about 3 millimetres. In some embodiments, the separation distance may be configured to be about 2 millimetres, about 3 millimetres, about 4 millimetres, about 5 millimetres, about 6 millimetres, about 7 millimetres, about 8 millimetres or about 9 millimetres.

In embodiments for use with non-shisha substrates, the first electrode of each electrode pair and the second electrode of each electrode pair are configured to be spaced apart by a separation distance of between about 0.1 millimetres and about 9 millimetres. For example, between about 0.1 millimetres and about 8 millimetres, between about 0.1 millimetres and about 7 millimetres, between about 0.1 millimetres and about 6 millimetres, between about 0.5 millimetres and about 6 millimetres, between about 1 millimetre and about 6 millimetres, between about 1 millimetre and about 5 millimetres, between about 1 millimetre and about 4 millimetres between about 1 millimetre and about 3 millimetres, between about 2 millimetres and about 3 millimetres.

In some embodiments, the first electrode of each pair of electrodes may comprise a first surface, and the second electrode of each pair of electrodes may comprise a second surface. The first surface of the first electrode may face the second surface of the second electrode. The surface area of the electrode surfaces is a factor that determines the electromagnetic field strength between them and, thus, the extent of dielectric heating. The surface area of the electrodes also, in part, determines the amount of the aerosol-forming substrate that is heated.

In some embodiments, the surface area of the first surface of the first electrode of a pair may be the same as the surface area of the second surface of the second electrode of the pair. In some embodiments, the surface area of the first surface of the first electrode of a pair may be different to the surface area of the second surface of the second electrode of the pair.

The surface area of each first surface may be between about 5 millimetres squared and about 3000 millimetres squared. In some preferred embodiments, the surface area of each first surface may be between about 20 millimetres squared and about 2000 millimetres squared. In some embodiments, the surface area of each second surface may be between about 5 millimetres squared and about 1000 millimetres squared. In some preferred embodiments, the surface area of each second surface may be between about 20 millimetres squared and about 500 millimetres squared.

Each electrode is electrically conductive. Each electrode may comprise an electrically conductive material, such as a metal.

In some preferred embodiments, the first electrode of each pair of electrodes may be substantially identical to the second electrode of each pair of electrodes. In some embodiments, each of the electrodes in the plurality of electrodes has a shape that is one of: rectangular, square, pentagonal, hexagonal or triangular. These shapes advantageously allow multiple adjacent pairs of electrodes to be spaced close together.

In some preferred embodiments, the first electrode of each pair of electrodes is substantially planar, and the second electrode of each pair is substantially planar. The first electrode of each pair may extend substantially in a first plane, and the second electrode of each pair may extend substantially in a second plane. The first plane may be substantially parallel to the second plane.

In some embodiments, the first electrode of each pair of electrodes may circumscribe the second electrode of the pair of electrodes. In some embodiments, the second electrode of each pair of electrodes may circumscribe the first electrode of the pair of electrodes. In some preferred embodiments, the first electrode of each pair of electrodes may be substantially coaxial with the second electrode of the pair of electrodes. In some particularly preferred embodiments, the first electrode and the second electrode of each pair of electrodes may be substantially cylindrical.

In some embodiments, the first electrode of each pair of electrodes may be annular, and define an internal passage. The second electrode of each pair of electrodes may be disposed in the internal passage of the first electrode of the pair. The plurality of pairs of electrodes may be disposed coaxially along a longitudinal axis.

In some embodiments, the aerosol-generating device may comprise the plurality of pairs of electrodes. In other embodiments, the aerosol-generating article may comprise the plurality of pairs of electrodes. In some embodiments, the aerosol-generating device may comprise the first electrode of each pair of electrodes and the aerosol-generating article may comprise the second electrode of each pair of electrodes. In other embodiments, the aerosol-generating device may comprise the second electrode of each pair of electrodes and the aerosol-generating article may comprise the first electrode of each pair of electrodes.

In some embodiments, at least one of the first electrode of each pair of electrodes and the second electrode of each pair of electrodes is gas permeable, to enable air to flow through the electrode. In some embodiments, at least a portion of at least one of the first electrode and the second electrode of each pair of electrodes may be formed from a gas permeable material. In some embodiments, one or more slots are formed in at least one of the first electrode and the second electrode of each pair of electrodes. The one or more slots may have any shape, size, number and arrangement to enable sufficient air to flow through the electrode.

The frequency of the alternating voltage supplied to the first electrode and the second electrode of each pair of electrodes for heating the aerosol-forming substrate may depend on factors such as the separation distance and the aerosol-forming substrate properties. In some embodiments, the frequency of the alternating voltage supplied to the first electrode and the second electrode of each pair of electrodes may be between 10 megahertz and 100 megahertz, preferably between about 10 megahertz and about 80 megahertz, more preferably between about 10 megahertz and about 40 megahertz, more preferably between about 10 megahertz and about 30 megahertz. In a preferred embodiment, the frequency of the alternating voltage supplied to the first electrode and the second electrode may be about 20 megahertz. The alternating voltage supplied to the first electrode and the second electrode may be a radio frequency (RF) alternating voltage. As used herein, the term ‘radio frequency (RF) alternating voltage’ refers to an alternating voltage that alternates at a frequency within the radio frequency (RF) range. As used herein, radio frequency (RF) means a frequency between about 20 kilohertz (kHz) and about 300 megahertz (MHZ). Accordingly, as used herein, RF frequencies include microwave frequencies.

The aerosol-generating device comprises a controller. The controller may comprise a microprocessor, a programmable microprocessor, a microcontroller, or an application specific integrated chip (ASIC) or other electronic circuitry capable of providing control. The controller may comprise further electronic components. For example, in some embodiments, the controller may comprise any of: sensors, switches, display elements. The controller may comprise an RF power sensor. The controller may comprise a power amplifier.

In some embodiments, the controller may be configured to control one or more relay-switch circuits, the relay-switch circuits operable to control the supply of the alternating voltage to one or more pairs of electrodes. In some embodiments, the one or more relay-switch circuits comprises a relay-switch circuit for each pair of electrodes, each relay-switch circuit operable to control the supply of the alternating voltage to one pair of electrodes. In other embodiments, the one or more relay-switch circuits comprises a first relay-switch circuit operable to control the supply of the alternating voltage to a first group of pairs of electrodes and a second relay-switch circuit operable to control the supply of the alternating voltage to a second group of pairs of electrodes.

In embodiments in which the controller has a memory, the memory may be volatile memory. In some embodiments, the memory may be non-volatile memory. Non-volatile memory may advantageously allow the aerosol-generating system to store parameters between usage sessions of the aerosol-generating system, when power is not supplied to the controller. For example, the aerosol-generating system may be able to determine which portions of aerosol-forming substrate have and have not been aerosolised in previous usage sessions.

The aerosol-generating device may comprise a power supply. The power supply may supply the alternating voltage to the pairs of electrodes for heating the aerosol-forming substrate. The power supply may be a rechargeable power supply. The power supply may be a DC power supply. The power supply may comprise at least one battery. The at least one battery may include a rechargeable lithium-ion battery. As an alternative, the power supply may be another form of charge storage device, such as a capacitor.

The aerosol-generating device may be configured to be connected to an external power source for recharging the rechargeable power source. In some embodiments, the aerosol-generating device is configured to be connected to an external power source. For example, the aerosol-generating device may be configured to be connected to a mains power source.

The power supply may provide a power of between about 10 Watts and about 60 Watts to the first electrode and the second electrode of each pair of electrodes.

Where the power supply is a DC power supply, the aerosol-generating device may further comprise a DC/AC converter. The DC/AC converter may be arranged to convert a DC voltage from the DC power supply to an AC voltage, which may be directly or indirectly supplied to the pairs of electrodes.

The aerosol-generating device may comprise a puff detector configured to detect when a user takes a puff on the aerosol-generating system. As used herein, the term “puff” is used to refer to a user drawing on the aerosol-generating system to receive aerosol. The puff detector may comprise a temperature sensor. The puff detector may comprise a pressure sensor. The puff detector may comprise both a temperature sensor and a pressure sensor. Where the aerosol-generating device comprises a puff detector, the controller may be configured to supply the alternating voltage to one or more of the pairs of electrodes for heating the aerosol-forming substrate when a puff is detected by the puff detector.

The aerosol-generating device may comprise an oscillation circuit. The oscillation circuit may be arranged to supply the alternating voltage to the pairs of electrodes for heating the aerosol-forming substrate. The oscillation circuit may be connected to the controller. The controller may be configured to control the oscillation circuit.

The oscillation circuitry may comprise a radio frequency (RF) signal generator. The oscillation circuitry may comprise a radio frequency (RF) signal generator for each pair of electrodes. The RF signal generator may be any suitable type of RF signal generator. In some embodiments, the RF signal generator is a solid-state RF transistor. Advantageously, a solid-state RF transistor may be configured to generate and amplify the RF electromagnetic field. Using a single transistor to provide both the generating and amplification of the RF electromagnetic field allows for an aerosol-generating device to be compact. The solid-state RF transistor may be, for example, a LDMOS transistor, a GaAs FET, a SiC MESFET or a GaN HFET.

In some embodiments, the oscillation circuitry may further comprise a frequency synthesizer disposed between the RF signal generator and the first electrode and the second electrode of each pair of electrodes. The oscillation circuitry may comprise a frequency synthesizer for each pair of electrodes.

In some embodiments, the oscillation circuitry may further comprise a phase shift network disposed between the RF signal generator and the first electrode and the second electrode of each pair of electrodes. Where the oscillation circuitry comprises a phase shift network, the phase shift network divides the RF energy received from the RF signal generator into two separate, equal components that are out of phase with each other. Typically, the phase shift network supplies one of the components to the first electrode of each pair of electrodes, and supplies the other component to the second electrode of each pair of electrodes. The two substantially equal components of the RF energy received from the RF signal generator are preferably substantially 90 degrees or 180 degrees out of phase with each other. The two substantially equal components may be any multiple of 90 degrees or 180 degrees out of phase with each other. It will be appreciated that the precise phase relationship between the two components is not essential, but rather that the two components are not in phase.

In some embodiments, the phase shift network is configured to divide the RF energy from the RF signal generator into two substantially equal components, one out of phase with the other, and each component is applied to a different one of the first electrode and the second electrode of each pair of electrodes.

In some embodiments, the oscillation circuitry may comprise a phase shift network for each pair of electrodes.

Preferably, the aerosol-generating device is portable. The aerosol-generating device may have a size comparable to a conventional cigar or cigarette. The aerosol-generating device may have a total length between about 30 millimetres and about 150 millimetres. The aerosol-generating device may have an outer diameter between about 5 millimetres and about 30 millimetres. The substrate cavity may have a diameter between 2 millimetres and 20 millimetres. The substrate cavity may have a length between 2 millimetres and 20 millimetres. The aerosol-generating device may be a personal vaporiser, an e-cigarette or heat-not-burn device.

In embodiments comprising an aerosol-generating article, the aerosol-generating article may take any suitable form.

The aerosol-generating article comprises the aerosol-forming substrate. In some preferred embodiments, the aerosol-generating article comprises one or more of the electrodes of the plurality of pairs of electrodes. The aerosol-generating article may have one or more additional components. For example, the aerosol-generating article may have a mouthpiece, such as a mouthpiece filter. The aerosol-generating article may have at least one of a cooling element and a spacing element.

In some preferred embodiments, the aerosol-generating article comprises a rod. The rod may be similar to a conventional cigarette or other smoking article.

In some embodiments, the aerosol-forming substrate is circumscribed by a wrapper. The wrapper may be a housing or a container. Providing a wrapper that circumscribes the aerosol-forming substrate may result in no, or a reduced, need to clean an aerosol-generating device that has received the aerosol-generating article. For example, in conventional aerosol-generating devices, during heating of the aerosol-forming substrate, residue may build up in an article cavity or on a heating element of a device. In some embodiments, the wrapper is configured to be pierced when inserted into the aerosol-generating device in order to permit airflow through the aerosol-forming substrate.

In some embodiments, the aerosol-forming substrate is circumscribed by a gas permeable wrapper. A gas permeable wrapper may permit airflow through the aerosol-generating article.

The gas permeable wrapper may be configured to permit airflow through the aerosol-generating article in a particular direction. For example, a first portion of the wrapper may be gas permeable, a second portion of the wrapper may be gas permeable, and a third portion of the wrapper may be gas impermeable. In use, airflow may enter the aerosol-forming substrate through the first portion of the wrapper that is gas permeable, and the airflow may exit the aerosol-forming substrate through the second portion of the wrapper that is gas permeable. That is, an airflow path may exist between the first portion of the wrapper that is gas permeable and a second portion of the wrapper that is gas permeable.

In some embodiments, the gas permeable wrapper may be electrically insulating. An electrically insulating gas permeable wrapper may ensure that the first electrode and the second electrode of each pair of electrodes do not come into electrical contact.

In some embodiments in which the aerosol-generating article comprises the plurality of pairs of electrodes, the first electrode and the second electrode of each pair of electrodes may be disposed at an outer surface of the aerosol-generating article. In some embodiments, the gas permeable wrapper may be disposed between the first electrode and the second electrode of each pair of electrodes.

In some embodiments, at least one of the first electrode and the second electrode of each pair of electrodes may form at least a portion of the gas permeable wrapper. At least one of the first electrode and the second electrode of each pair of electrodes forming at least a portion of the gas permeable wrapper may simplify manufacturing and reduce material costs.

The gas permeable wrapper may be formed from any suitable material. In some preferred embodiments, the gas permeable wrapper may comprise at least one of a cellulose-based material, polypropylene and polyethylene.

It may be advantageous to control the airflow through the aerosol-generating article. The airflow through the aerosol-generating article may be controlled passively, such as by defining an airflow path through the article. Controlling the airflow may result in improved airflow through the aerosol-forming substrate, subsequently resulting in improved aerosol production. In some embodiments, a first outer portion the aerosol-generating article may be gas permeable and a second outer portion the aerosol-generating article may be gas permeable. An airflow path may extend through the aerosol-generating article between the first outer portion of the aerosol-generating article and the second outer portion of the aerosol-generating article. Remaining outer portions of the aerosol-generating may be substantially gas impermeable. The airflow path may extend through at least a portion of the aerosol-forming substrate. When the aerosol-generating article is received in the article cavity of the aerosol-generating device, the airflow path of the aerosol-generating article may define a portion of the airflow path between the mouthpiece and air inlet of an aerosol-generating device.

In some embodiments, the aerosol-generating article is gas permeable in a first direction and substantially gas impermeable in a second direction, perpendicular to the first direction. In some embodiments, the aerosol-generating article is gas permeable in a transverse direction and substantially gas impermeable in a longitudinal direction, perpendicular to the transverse direction. The first outer portion of the aerosol-generating article may be a first outer surface and the second outer portion may be a second outer surface. The first outer surface may oppose the second outer surface. The first electrode of each pair of electrodes may be disposed at the first outer surface. The second electrode of each pair of electrodes may be disposed at the second outer surface. At least a portion of the aerosol-forming substrate may be disposed between the first outer surface and the second outer surface. At least a portion of the aerosol-forming substrate may be disposed between the first electrode and the second electrode of each pair of electrodes. An airflow path may extend between the first outer surface and the second outer surface.

In some embodiments, the aerosol-generating article has a thickness of between about 2 millimetres and about 10 millimetres. The thickness of the aerosol-generating article may be between about 3 millimetres and about 9 millimetres, or between about 4 millimetres and about 8 millimetres.

In some embodiments in which the aerosol-generating article comprises a plurality of pairs of electrodes, a portion of aerosol-forming substrate is disposed between each pair of electrodes, and the portion of aerosol-forming substrate disposed between a pair of electrodes is spaced from portions of aerosol-forming substrate disposed between other pairs of electrodes. In some embodiments, each portion of aerosol-forming substrate is thermally separated from other portions of aerosol-forming substrate. In some embodiments, each portion of aerosol-forming substrate is separated from other portions of aerosol-forming substrate by a material opaque to the RF electromagnetic field.

In some embodiments, a portion of aerosol-forming substrate disposed between a first pair of electrodes is different from a portion of aerosol-forming substrate disposed between a second pair of electrodes. In some embodiments, the amount of aerosol-forming substrate disposed between each pair of electrodes is different.

The aerosol-generating article may have any suitable shape. Where the aerosol-generating device comprises an article cavity, the aerosol-generating article may have a shape that corresponds to the shape of the article cavity of an aerosol-generating device.

In some embodiments, the aerosol-generating article may be substantially disc shaped.

In some embodiments, the aerosol-generating article may have the shape of a prism. The aerosol-generating article may have a first planar outer surface having a first shape. The aerosol-generating article may have a second planar outer surface having a second shape. The first shape may be substantially identical to the second shape. The first planar outer surface may oppose the second planar outer surface. The aerosol-generating article may have a constant cross-sectional shape between the first planar outer surface and the second planar outer surface. The constant cross-sectional shape may be substantially identical to the first shape and the second shape. The first electrode may be disposed at the first planar outer surface and the second electrode may be disposed at the second planar outer surface. The first electrode may be the first planar outer surface. The second electrode may be the second planar outer surface.

In some embodiments, the first electrode of a pair of electrodes may be arranged at a first end of the aerosol-generating article, and the second electrode of the pair of electrodes may be arranged at a second end of the aerosol-generating article, opposite the first end.

In some preferred embodiments, the aerosol-generating article may have a substantially annular cylindrical shape. In some embodiments, the annular cylindrical article has a curved outer surface. The annular cylindrical article may have a passage extending through the article defined by an inner surface. One of the first electrode and the second electrode of a pair of electrodes may be arranged at the curved outer surface. The other one of the first electrode and the second electrode of the pair of electrodes may be arranged at the inner surface. The electrode arranged at the outer surface may substantially circumscribe the aerosol-forming substrate. The aerosol-forming substrate may have a tubular shape. In some embodiments, the aerosol-generating article is gas permeable in a direction extending between the inner surface and the curved outer surface. In some embodiments, a portion the inner surface may be gas permeable, a portion of the outer surface may be gas permeable and the remaining portions of the inner and outer surfaces of the aerosol-generating article may be substantially gas impermeable. An airflow path may extend through the aerosol-generating article between the gas permeable portion of the inner surface and the gas permeable portion of the outer surface. The airflow path may extend through at least a portion of the aerosol-forming substrate. When the aerosol-generating article is received in an article cavity of the aerosol-generating device, the airflow path of the aerosol-generating article may define a portion of an airflow path through the aerosol-generating system. The airflow path may extend between a mouthpiece of the aerosol-generating system and an air inlet of the aerosol-generating device.

The aerosol-forming substrate may take any suitable form. The aerosol-forming substrate may be solid or liquid or comprise both solid and liquid components.

The aerosol-forming substrate may include nicotine. The nicotine containing aerosol-forming substrate may include a nicotine salt matrix. The aerosol-forming substrate may include plant-based material. The aerosol-forming substrate preferably includes tobacco. The tobacco containing material preferably contains volatile tobacco flavour compounds, which are released from the aerosol-forming substrate upon heating. The aerosol-forming substrate may include homogenized tobacco material. Homogenized tobacco material may be formed by agglomerating particulate tobacco. The aerosol-forming substrate may include a non-tobacco-containing material. The aerosol-forming substrate may include homogenized plant-based material.

The aerosol-forming substrate may include, for example, one or more of: powder, granules, pellets, shreds, spaghettis, strips, or sheets. The aerosol-forming substrate may contain one or more of: herb leaf, tobacco leaf, fragments of tobacco ribs, reconstituted tobacco, homogenized tobacco, extruded tobacco, and expanded tobacco. The tobacco may be flue cured.

The aerosol-forming substrate may include at least one aerosol former. Suitable aerosol formers include compounds or mixtures of compounds which, in use, facilitate formation of a dense and stable aerosol and which are substantially resistant to thermal degradation at the operating temperature of the shisha device. Suitable aerosol formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Particularly preferred aerosol formers are polyhydric alcohols or mixtures thereof, such as triethylene glycol, 1,3-butanediol and, most preferred, glycerine. The aerosol-former may be propylene glycol. The aerosol-forming substrate may include any suitable amount of an aerosol former. For example, the aerosol former content of the substrate may be equal to or greater than 5 percent on a dry weight basis, and preferably greater than 30 percent by weight on a dry weight basis. The aerosol former content may be less than about 95 percent on a dry weight basis. Preferably, the aerosol former content is up to about 55 percent on a dry weight basis.

The aerosol-forming substrate preferably includes nicotine and at least one aerosol former. In some embodiments, the aerosol former is glycerine or a mixture of glycerine and one or more other suitable aerosol formers, such as those listed above. In some embodiments, the aerosol-forming is propylene glycol.

In some embodiments, the aerosol-forming substrate may comprise at least one of: water, glycerol, and propylene glycol.

The aerosol-forming substrate may include other additives and ingredients, such as flavourants. In some examples, the aerosol-forming substrate includes one or more sugars in any suitable amount. Preferably, the aerosol-forming substrate includes invert sugar. Invert sugar is a mixture of glucose and fructose obtained by splitting sucrose. Preferably, the aerosol-forming substrate includes between about 1 percent and about 40 percent sugar, such as invert sugar, by weight. In some example, one or more sugars may be mixed with a suitable carrier such as cornstarch or maltodextrin.

In some examples, the aerosol-forming substrate includes one or more sensory-enhancing agents. Suitable sensory-enhancing agents include flavourants and sensation agents, such as cooling agents. Suitable flavourants include natural or synthetic menthol, peppermint, spearmint, coffee, tea, spices (such as cinnamon, clove, ginger, or combination thereof), cocoa, vanilla, fruit flavours, chocolate, eucalyptus, geranium, eugenol, agave, juniper, anethole, linalool, and any combination thereof.

Any suitable amount of aerosol-forming substrate, such as molasses or tobacco substrate, may be provided in the aerosol-generating article. In some preferred embodiments, about 3 grams to about 25 grams of the aerosol-forming substrate is provided in the aerosol-generating article. The cartridge may include at least 6 grams, at least 7 grams, at least 8 grams, or at least 9 grams of aerosol-forming substrate. The cartridge may include up to 15 grams, up to 12 grams; up to 11 grams, or up to 10 grams of aerosol-forming substrate. Preferably, from about 7 grams to about 13 grams of aerosol-forming substrate is provided in the aerosol-generating article.

The aerosol-forming substrate may be provided on or embedded in a thermally stable carrier. The term “thermally stable” is used herein to indicate a material that does not substantially degrade at temperatures to which the substrate is typically heated (e.g., about 150° C. to about 300°) C. The carrier may comprise a thin layer on which the substrate deposited on a first major surface, on second major outer surface, or on both the first and second major surfaces. The carrier may be formed of, for example, a paper, or paper-like material, a non-woven carbon fibre mat, a low mass open mesh metallic screen, or a perforated metallic foil or any other thermally stable polymer matrix. Alternatively, the carrier may take the form of powder, granules, pellets, shreds, spaghettis, strips or sheets. The carrier may be a non-woven fabric or fibre bundle into which tobacco components have been incorporated. The non-woven fabric or fibre bundle may comprise, for example, carbon fibres, natural cellulose fibres, or cellulose-derivative fibres.

In some preferred embodiments, the aerosol-forming substrate may comprise tobacco, sugar and an aerosol-former. In these embodiments, the aerosol-forming substrate may comprise between 10 percent and 40 percent by weight of tobacco. In these embodiments, the aerosol-forming substrate may comprise between 20 percent and 50 percent by weight of sugar. In these embodiments, the aerosol-forming substrate may comprise between 25 percent and 55 percent by weight of aerosol-former. In some particularly preferred embodiments, the aerosol-forming substrate comprises between 20 percent and 30 percent by weight of tobacco, between 30 percent and 40 percent by weight of sugar, and between 35 percent and 45 percent by weight of aerosol-former. In some preferred embodiments, the aerosol-forming substrate may comprise about 25 percent by weight of tobacco, about 35 percent by weight of sugar and about 40 percent by weight of aerosol-former. In some preferred embodiments, the aerosol-forming substrate may comprise between about 15 percent and about 30 percent by weight of tobacco, between about 15 percent and about 30 percent by weight of sugar and between about 45 percent and about 55 percent by weight of aerosol-former. In these preferred embodiments, the tobacco may be flue cured tobacco leaf. In these preferred embodiments, the sugar may be sucrose or invert sugar. In these preferred embodiments, the aerosol-former may be propylene glycol.

In some embodiments, the aerosol-generating system may be a shisha system. In some embodiments, the aerosol-generating device may be a shisha device. The aerosol-generating system may be a shisha system having a shisha device. Shisha devices are different to other aerosol-generating devices, at least in that volatile compounds released from a heated substrate are drawn through a liquid basin of the shisha device before inhalation by a user. A shisha device may include more than one outlet so that the device may be used by more than one user at a time. A shisha device may comprise an airflow conduit, such as a stem pipe, for directing volatile compounds released from the aerosol-forming substrate to the liquid basin.

As used herein, the term “shisha system” refers to the combination of a shisha device with an aerosol-forming substrate or with an aerosol-generating article comprising an aerosol-forming substrate. In the shisha system, the aerosol-forming substrate or an aerosol-generating article comprising the aerosol-forming substrate and the shisha device cooperate to generate an aerosol.

A shisha device differs from other aerosol-generating devices in that the aerosol generated by a shisha device is drawn through a volume of liquid, typically water, before inhalation of the aerosol by a user. In more detail, when a user draws on a shisha device, volatile compounds released from a heated aerosol-forming substrate are drawn through an airflow conduit of the shisha device into a volume of liquid. The volatile compounds are drawn out of the volume of liquid into a headspace of the shisha device, in which the volatile compounds form an aerosol. The aerosol in the headspace is then drawn out of the headspace at a headspace outlet for inhalation by a user. The volume of liquid, typically water, acts to reduce the temperature of the volatile compounds, and may impart additional water content to the aerosol formed in the headspace of the shisha device. This process adds distinctive characteristics to the process of using a shisha device for a user, and imparts distinctive characteristics to the aerosol generated by the shisha device and inhaled by a user.

The shisha device may comprise a liquid cavity configured to contain a volume of liquid. The liquid cavity may comprise a head space outlet. The shisha device may include a vessel. The liquid cavity may be an interior volume of a vessel. The vessel may be configured to contain a liquid. The vessel may define the liquid cavity. The vessel may comprise the headspace outlet. The vessel may define a liquid fill level. For example, the vessel may comprise a liquid fill level demarcation. A liquid fill level demarcation is an indicator provided on the vessel to indicate the desired level to which the liquid cavity is intended to be filled with liquid. The headspace outlet may be arranged above the liquid fill level. The headspace outlet may be arranged above the liquid fill level demarcation. The vessel may comprise an optically transparent portion. The optically transparent portion may enable a user to observe the contents contained in the vessel. The vessel may be formed from any suitable material. For example, the vessel may be formed from glass or a rigid plastic material. In some embodiments, the vessel is removable from the rest of the shisha assembly. In some embodiments, the vessel is removable from an aerosol-generating portion of the shisha assembly. Advantageously, a removable vessel enables a user to fill the liquid cavity with liquid, empty the liquid cavity of liquid, and clean the vessel.

The vessel may be filled to a liquid fill level by a user. The liquid preferably comprises water. The liquid may comprise water infused with one or more of colorants and flavourants. For example, the water may be infused with one or both of botanical and herbal infusions.

The vessel may have any suitable shape and size. The liquid cavity may have any suitable shape and size. The headspace may have any suitable shape and size.

Typically, a shisha device according to this disclosure is intended to be placed on a surface in use, rather than being carried by a user. As such, a shisha device according to this disclosure may have a particular use orientation, or range of orientations, at which the device is intended to be oriented during use. Accordingly, as used herein, the terms ‘above’ and ‘below’ refer to relative positions of features of a shisha device or a shisha system when the shisha device or shisha system is held in a use orientation.

The shisha device may comprise an article cavity for receiving an aerosol-generating article. In some embodiments, the article cavity is arranged above the liquid cavity. In these embodiments, an airflow conduit may extend from the article cavity to below a liquid fill level of the liquid cavity. Advantageously, this may ensure that volatile compounds released from aerosol-forming substrate in the article cavity are delivered from the article cavity to the volume of liquid in the liquid cavity, rather than to the headspace above the liquid cavity. In these embodiments, the airflow conduit may extend from the aerosol cavity into the liquid cavity through the headspace in the liquid cavity above the liquid fill level, and into the volume of liquid below the liquid fill level. The airflow conduit may extend into the liquid cavity through a top or upper end of the liquid cavity.

In some embodiments, the article cavity is arranged below the liquid cavity. In these embodiments, a one-way valve may be arranged between the article cavity and the liquid cavity. The one-way valve may prevent liquid from the liquid cavity from entering the article cavity under the influence of gravity. In these embodiments, the one-way valve may be provided in an airflow conduit extending from the article cavity into the liquid cavity. In these embodiments, the airflow conduit may extend into the liquid cavity to below the liquid fill level. The airflow conduit may extend into the liquid cavity through a bottom end of the liquid cavity.

The shisha device may comprise a plurality of headspace outlets. For example, the shisha device may comprise two, three, four, five or six headspace outlets. Providing more than one headspace outlet may enable more than one user to draw aerosol from the liquid cavity at a time. In other words, providing a plurality of headspace outlets may enable a plurality of users to use the shisha device simultaneously

The aerosol-forming substrate may be a shisha aerosol-forming substrate. A shisha aerosol-forming substrate may also be referred to in the art as hookah tobacco, tobacco molasses, or simply as molasses. A shisha aerosol-forming substrate may be relatively high in sugar, compared to conventional combustible cigarettes or tobacco based consumable items intended to be heated without burning to simulate a smoking experience.

In some preferred embodiments, the aerosol-forming substrate is in the form of a suspension. For example, the aerosol-forming substrate may include molasses. As used herein, “molasses” means an aerosol-forming substrate composition comprising a suspension having at least about 20 percent by weight of sugar. For example, the molasses may include at least about 25 percent by weight of sugar, such as at least about 35 percent by weight of sugar. Typically, the molasses will contain less than about 60 percent by weight of sugar, such as less than about 50 percent by weight of sugar.

Preferably, the aerosol-forming substrate used in the shisha system is a shisha substrate. As used herein, a “shisha substrate” refers to an aerosol-forming substrate composition comprising at least about 20 percent by weight of sugar. A shisha substrate may comprise molasses. A shisha substrate may comprise a suspension having at least about 20 percent by weight of sugar.

The aerosol-forming substrate preferably includes nicotine and at least one aerosol former. In some embodiments, the aerosol former is glycerine or a mixture of glycerine and one or more other suitable aerosol formers, such as those listed above. In some embodiments, the aerosol-forming is propylene glycol.

The aerosol-forming substrate may include other additives and ingredients, such as flavourants. In some examples, the aerosol-forming substrate includes one or more sugars in any suitable amount. Preferably, the aerosol-forming substrate includes invert sugar. Invert sugar is a mixture of glucose and fructose obtained by splitting sucrose. Preferably, the aerosol-forming substrate includes between about 1 percent and about 40 percent sugar, such as invert sugar, by weight. In some example, one or more sugars may be mixed with a suitable carrier such as cornstarch or maltodextrin.

Any suitable amount of aerosol-forming substrate, such as molasses or tobacco substrate, may be provided in the aerosol-generating article. In some preferred embodiments, about 3 grams to about 25 grams of the aerosol-forming substrate is provided in the aerosol-generating article. The cartridge may include at least 6 grams, at least 7 grams, at least 8 grams, or at least 9 grams of aerosol-forming substrate. The cartridge may include up to 15 grams, up to 12 grams; up to 11 grams, or up to 10 grams of aerosol-forming substrate. Preferably, from about 7 grams to about 13 grams of aerosol-forming substrate is provided in the aerosol-generating article.

In some preferred embodiments, the aerosol-forming substrate may comprise tobacco, sugar and an aerosol-former. In these embodiments, the aerosol-forming substrate may comprise between 10 percent and 40 percent by weight of tobacco. In these embodiments, the aerosol-forming substrate may comprise between 20 percent and 50 percent by weight of sugar. In these embodiments, the aerosol-forming substrate may comprise between 25 percent and 55 percent by weight of aerosol-former.

In this disclosure, there is provided a method of dielectrically heating an aerosol-forming substrate in an aerosol-generating system. The aerosol-generating system comprises an aerosol-forming substrate. The aerosol-generating system comprises a plurality of pairs of electrodes, each pair of electrodes comprising a first electrode spaced apart from a second electrode. The aerosol-generating system comprises an aerosol-generating device. The aerosol-generating device comprises a controller configured to connect to each pair of electrodes. The method comprises the steps of arranging each pair of electrodes to form a capacitor with a portion of the aerosol-forming substrate, and supplying an alternating voltage to one or more of the pairs of electrodes for dielectrically heating the aerosol-forming substrate.

In some embodiments, the method may comprise selectively supplying the alternating voltage to individual pairs of the plurality of pairs of electrodes.

In some embodiments, the method may comprise supplying the alternating voltage to each selected pair of electrodes for between 30 seconds and 180 seconds.

In some embodiments, the aerosol-generating device may comprise a puff sensor configured to sense a puff of a user on the aerosol-generating system, and the method may comprise supplying the alternating voltage to one selected pair of electrodes when a first puff of a user is detected on the aerosol-generating system, and subsequently supplying the voltage to another selected pair of electrodes when a second, subsequent puff of a user is detected on the aerosol-generating system.

It should be appreciated that features described in relation to an aerosol-generating device or an aerosol-generating article may also be applicable to an aerosol-generating system according to the disclosure.

It should also be appreciated that particular combinations of the various features described above may be implemented, supplied, and used independently.

Below, there is provided a non-exhaustive list of non-limiting examples. Any one or more of the features of these examples may be combined with any one or more features of another example, embodiment, or aspect described herein.

Ex1. A dielectrically heated aerosol-generating system, comprising:
an aerosol-forming substrate;
a plurality of pairs of electrodes, each pair of electrodes comprising a first electrode spaced apart from a second electrode; and
an aerosol-generating device comprising:
   a controller configured to connect to each pair of electrodes,
wherein each pair of electrodes forms a capacitor with a portion of the aerosol-forming substrate; and
wherein the controller is configured to supply an alternating voltage to the plurality of pairs of electrodes for dielectrically heating the aerosol-forming substrate.

Ex2. An aerosol-generating system according to Ex1, wherein the controller is configured to selectively control the supply of the alternating voltage to each pair of electrodes.

Ex3. An aerosol-generating system according to Ex2, wherein the controller is configured to selectively supply the alternating voltage to each pair of electrodes in a sequence.

Ex4. An aerosol-generating system according to Ex3, wherein the sequence is a predetermined sequence.

Ex5. An aerosol-generating system according to Ex3, wherein the controller is configured to determine a sequence of supply of the alternating voltage to each pair of electrodes.

Ex6. An aerosol-generating system according to Ex5, wherein the sequence is determined based on at least one of: a temperature of one or more of the plurality of pairs of electrodes, a temperature of the aerosol-forming substrate, a temperature adjacent to the aerosol-forming substrate, an activation of a puff sensor, and a duration of supply of the alternating voltage to one or more of the plurality of pairs of electrodes.

Ex7. An aerosol-generating system according to any one of Ex1 to Ex6, wherein the controller is configured to monitor which of the plurality of pairs of electrodes has received the supply of the alternating voltage, and wherein the controller comprises a memory configured to store which of the plurality of pairs of electrodes has received the supply of the alternating voltage.

Ex8. An aerosol-generating system according to any one of Ex1 to Ex7, wherein the plurality of pairs of electrodes comprises between 2 and 15 pairs of electrodes, and preferably between 5 and 12 pairs of electrodes.

Ex9. An aerosol-generating system according to any one of Ex1 to Ex8, wherein the plurality of pairs of electrodes comprises 9 pairs of electrodes.

Ex10. An aerosol-generating system according to any one of Ex1 to Ex9, wherein the first electrodes of the plurality of pairs of electrodes form a first array of electrodes, each electrode in the first array of electrodes being spaced apart by an electrode spacing distance, and wherein the second electrodes of the plurality of pairs of electrodes form a second array of electrodes, each electrode in the second array of electrodes being spaced apart by the electrode spacing distance.

Ex11. An aerosol-generating system according to Ex10, wherein the electrode spacing distance is between about 0.1 millimetres and about 2 millimetres, preferably between about 0.5 millimetres and about 1.5 millimetres.

Ex12. An aerosol-generating system according to any one of Ex10 or Ex11, wherein the electrode spacing distance is about 1 millimetre.

Ex13. An aerosol-generating system according to any one of Ex10 to Ex12, wherein a first electrically insulative material is arranged between adjacent electrodes in the first electrode array, and wherein a second electrically insulative material is arranged between adjacent electrodes in the second electrode array.

Ex14. An aerosol-generating system according to Ex13, wherein at least one of the first electrically insulative material and the second electrically insulative material comprises at least one of PEEK, PAEK, PPSU and a ceramic.

Ex15. An aerosol-generating system according to any one of Ex10 to Ex14, wherein the first electrodes of the first array of electrodes are substantially tessellated, and wherein the second electrodes in the second array of electrodes are substantially tessellated.

Ex16. An aerosol-generating system according to any one of Ex1 to Ex15, wherein the first electrode of each pair of electrodes is arranged substantially parallel to the second electrode of the pair of electrodes.

Ex17. An aerosol-generating system according to any one of Ex1 to Ex16, wherein the first electrode of each pair of electrodes has a first length and the second electrode of each pair of electrodes has a second length, substantially the same as the first length.

Ex18. An aerosol-generating system according to Ex17, wherein the first lengths of the first electrodes of each pair of electrodes are substantially the same.

Ex19. An aerosol-generating system according to Ex17, wherein the first length of one of the first electrodes of the plurality of pairs of electrodes is different from the first length of another one of the first electrodes of the plurality of electrodes.

Ex20. An aerosol-generating system according to any one of Ex1 to Ex19, wherein the first electrode of each pair of electrodes is substantially identical to the second electrode of each pair of electrodes.

Ex21. An aerosol-generating system according to Ex20, wherein each electrode of the plurality of electrodes has a shape that is one of: rectangular, square, pentagonal, hexagonal or triangular.

Ex22. An aerosol-generating system according to any one of Ex1 to Ex21, wherein the first electrode of each pair of electrodes is planar, extending substantially in a first plane, and the second electrode of each pair of electrodes is planar, extending substantially in a second plane.

Ex23. An aerosol-generating system according to Ex22, wherein the first plane is substantially parallel to the second plane.

Ex24. An aerosol-generating system according to claim any one of Ex1 to Ex23, wherein the first electrode of each pair of electrodes circumscribes the second electrode of the pair of electrodes.

Ex25. An aerosol-generating system according to Ex24, wherein the first electrode of each pair of electrodes is substantially coaxial with the second electrode of the pair of electrodes.

Ex26. An aerosol-generating system according to any one of Ex24 or Ex25, wherein the first electrode and the second electrode of each pair of electrodes are substantially cylindrical.

Ex27. An aerosol-generating system according to any one of Ex24 to Ex26, wherein the first electrode of each pair of electrodes is annular, defining an internal passage, wherein the second electrode of each pair of electrodes is disposed in the internal passage of the first electrode.

EX28. An aerosol-generating system according to any one of Ex1 to Ex27, wherein the aerosol-generating system comprises an aerosol-generating article comprising the aerosol-forming substrate.

Ex29. An aerosol-generating system according to any one of Ex1 to Ex28, wherein aerosol-generating device comprises the plurality of pairs of electrodes.

Ex30. An aerosol-generating system according to any one of Ex1 to Ex27, wherein the aerosol-generating system comprises an aerosol-generating article, and wherein the aerosol-generating article comprises the aerosol-forming substrate and at least one electrode of the plurality of pairs of electrodes.

Ex31. An aerosol-generating system according to Ex30, wherein the aerosol-generating article comprises at least one pair of electrodes of the plurality of pairs of electrodes.

Ex32. An aerosol-generating system according to Ex30 or Ex31, wherein the aerosol-generating article comprises the plurality of pairs of electrodes.

Ex33. An aerosol-generating system according to Ex30, wherein the aerosol-generating device comprises the first electrode of each pair of electrodes and wherein the aerosol-generating article comprises the second electrode of each pair of electrodes.

Ex34. An aerosol-generating system according to Ex30, wherein the aerosol-generating device comprises the second electrode of each pair of electrodes and wherein the aerosol-generating article comprises the first electrode of each pair of electrodes.

Ex35. An aerosol-generating system according to any one of Ex1 to Ex34, wherein the aerosol-generating system is a shisha system, and wherein the aerosol-generating device is a shisha device.

Ex36. A shisha system according to Ex35, wherein the shisha device comprises:
a liquid cavity configured to contain a volume of liquid through which aerosol generated by the shisha device is drawn before inhalation by a user, the liquid cavity having a head space outlet; and
an article cavity configured to receive the aerosol-forming substrate, the article cavity being in fluid communication with the liquid cavity.

Ex37. A dielectrically heated aerosol-generating device, comprising:
a plurality of pairs of electrodes, each pair of electrodes comprising a first electrode spaced apart from a second electrode; and
a controller connected to each pair of electrodes,
wherein the device is configured to receive an aerosol-forming substrate, each pair of electrodes forming a capacitor with at least a portion of the aerosol-forming substrate, and wherein the controller is configured to supply an alternating voltage to the plurality of pairs of electrodes for dielectrically heating the aerosol-forming substrate.

Ex38. An aerosol-generating device according to Ex37, wherein the controller is configured to selectively control the supply of the alternating voltage to each pair of electrodes.

Ex39. An aerosol-generating device according to Ex38, wherein the controller is configured to selectively supply the alternating voltage to each pair of electrodes in a sequence.

Ex40. An aerosol-generating device according to Ex39, wherein the sequence is a predetermined sequence.

Ex41. An aerosol-generating device according to Ex39, wherein the controller is configured to determine a sequence of supply of the alternating voltage to each pair of electrodes.

Ex42. An aerosol-generating device according to Ex41, wherein the sequence is determined based on at least one of: a temperature of one or more of the plurality of pairs of electrodes, a temperature of the aerosol-forming substrate, a temperature adjacent to the aerosol-forming substrate, an activation of a puff sensor, and a duration of supply of the alternating voltage to one or more of the plurality of pairs of electrodes.

Ex43. An aerosol-generating device according to any one of Ex37 to Ex42, wherein the controller is configured to monitor which of the plurality of pairs of electrodes has received the supply of the alternating voltage, and wherein the controller comprises a memory configured to store which of the plurality of pairs of electrodes has received the supply of the alternating voltage.

Ex44. An aerosol-generating article for a dielectrically heated aerosol-generating system, the aerosol-generating article comprising:
an aerosol-forming substrate; and
a plurality of pairs of electrodes, each pair of electrodes comprising a first electrode spaced apart from a second electrode,
wherein each pair of electrodes forms a capacitor with at least a portion of the aerosol-forming substrate.

Ex45. An aerosol-generating article according to Ex44, wherein the plurality of pairs of electrodes comprises between 2 and 15 pairs of electrodes, and preferably between 5 and 12 pairs of electrodes.

Ex46. An aerosol-generating article according to Ex44 or Ex45, wherein the plurality of pairs of electrodes comprises 9 pairs of electrodes.

Ex47. An aerosol-generating article according to any one of Ex44 to Ex46, wherein the first electrodes of the plurality of pairs of electrodes form a first array of electrodes, each electrode in the first array of electrodes being spaced apart by an electrode spacing distance, and wherein the second electrodes of the plurality of pairs of electrodes form a second array of electrodes, each electrode in the second array of electrodes being spaced apart by the electrode spacing distance.

Ex48. An aerosol-generating article according to Ex47, wherein the electrode spacing distance is between about 0.1 millimetres and about 2 millimetres, preferably between about 0.5 millimetres and about 1.5 millimetres.

Ex49. An aerosol-generating article according to any one of Ex47 or Ex48, wherein the electrode spacing distance is about 1 millimetre.

Ex50. An aerosol-generating article according to any one of Ex47 to Ex49, wherein a first electrically insulative material is arranged between adjacent electrodes in the first electrode array, and wherein a second electrically insulative material is arranged between adjacent electrodes in the second electrode array.

Ex51. An aerosol-generating article according to Ex50, wherein at least one of the first electrically insulative material and the second electrically insulative material comprises at least one of PEEK, PAEK, PPSU and a ceramic.

Ex52. An aerosol-generating article according to any one of Ex47 to Ex51, wherein the first electrodes of the first array of electrodes are substantially tessellated, and wherein the second electrodes in the second array of electrodes are substantially tessellated.

Ex53. An aerosol-generating article according to any one of Ex44 to Ex52, wherein the first electrode of each pair of electrodes is arranged substantially parallel to the second electrode of the pair of electrodes.

Ex54. An aerosol-generating article according to any one of Ex44 to Ex53, wherein the first electrode of each pair of electrodes has a first length and the second electrode of each pair of electrodes has a second length, substantially the same as the first length.

Ex55. An aerosol-generating article according to Ex54, wherein the first lengths of the first electrodes of each pair of electrodes are substantially the same.

Ex56. An aerosol-generating article according to Ex54, wherein the first length of one of the first electrodes of the plurality of pairs of electrodes is different from the first length of another one of the first electrodes of the plurality of electrodes.

Ex57. An aerosol-generating article according to any one of Ex44 to Ex56, wherein the first electrode of each pair of electrodes is substantially identical to the second electrode of each pair of electrodes.

Ex58. An aerosol-generating article according to Ex57, wherein each electrode of the plurality of electrodes has a shape that is one of: rectangular, square, pentagonal, hexagonal or triangular.

Ex59. An aerosol-generating article according to any one of Ex44 to Ex58, wherein the first electrode of each pair of electrodes is planar, extending substantially in a first plane, and the second electrode of each pair of electrodes is planar, extending substantially in a second plane.

Ex60. An aerosol-generating article according to Ex60, wherein the first plane is substantially parallel to the second plane.

Ex61. An aerosol-generating article according to claim any one of Ex44 to Ex58, wherein the first electrode of each pair of electrodes circumscribes the second electrode of the pair of electrodes.

Ex62. An aerosol-generating article according to Ex61, wherein the first electrode of each pair of electrodes is substantially coaxial with the second electrode of the pair of electrodes.

Ex63. An aerosol-generating article according to Ex61 or Ex62, wherein the first electrode and the second electrode of each pair of electrodes are substantially cylindrical.

Ex64. An aerosol-generating article according to any one of Ex61 to Ex63, wherein the first electrode of each pair of electrodes is annular, defining an internal passage, wherein the second electrode of each pair of electrodes is disposed in the internal passage of the first electrode

Ex65. A method of dielectrically heating an aerosol-forming substrate in an aerosol-generating system, the aerosol-generating system comprising:
an aerosol-forming substrate;
a plurality of pairs of electrodes, each pair of electrodes comprising a first electrode spaced apart from a second electrode; and
an aerosol-generating device comprising a controller configured to connect to each pair of electrodes,
   the method comprising:
arranging each pair of electrodes to form a capacitor with a portion of the aerosol-forming substrate, and
supplying an alternating voltage to one or more of the pairs of electrodes for dielectrically heating the aerosol-forming substrate.

Ex66. A method according to Ex65 comprising selectively supplying the alternating voltage to individual pairs of the plurality of pairs of electrodes.

Ex67. A method according to Ex66 comprising supplying the alternating voltage to each selected pair of electrodes for between 30 seconds and 180 seconds.

Ex68. A method according to Ex66 or EX67, wherein the aerosol-generating device comprises a puff sensor configured to sense a puff of a user on the aerosol-generating system, and wherein the method comprises supplying the alternating voltage to one selected pair of electrodes when a first puff of a user is detected on the aerosol-generating system, and subsequently supplying the alternating voltage to another selected pair of electrodes when a second, subsequent puff of a user is detected on the aerosol-generating system.

Embodiments of the present disclosure will now be described, by way of example only, with reference to the accompanying drawings, in which:

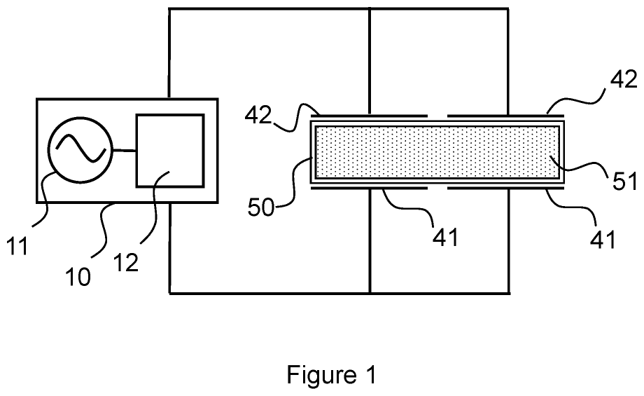

FIG. 1 is a schematic illustration of a dielectrically heated aerosol-generating system according to embodiments of this disclosure;

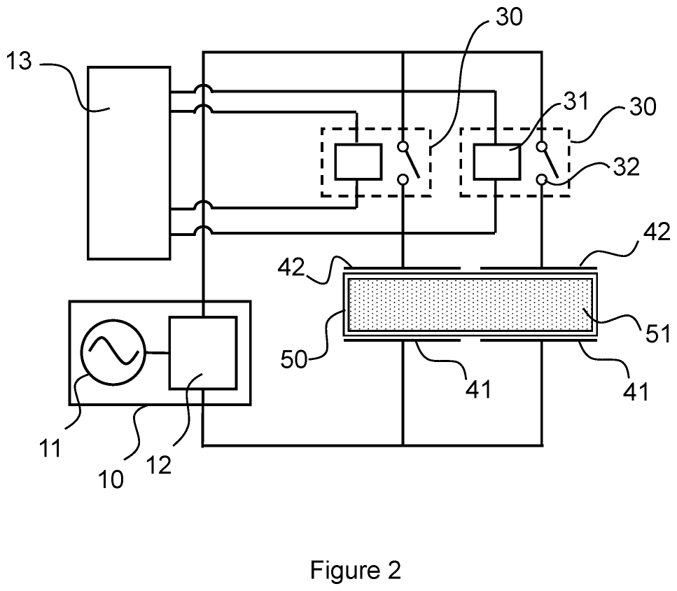

FIG. 2 is a schematic illustration of a dielectrically heated aerosol-generating system according to another embodiment of this disclosure;

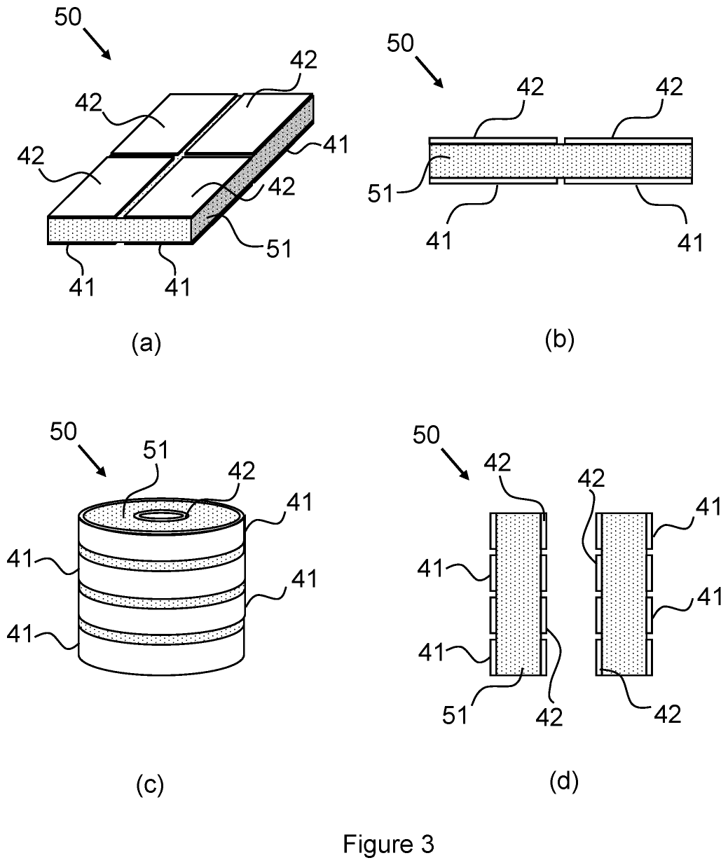

FIG. 3 is a schematic illustration of aerosol-generating articles according to embodiments of this disclosure;

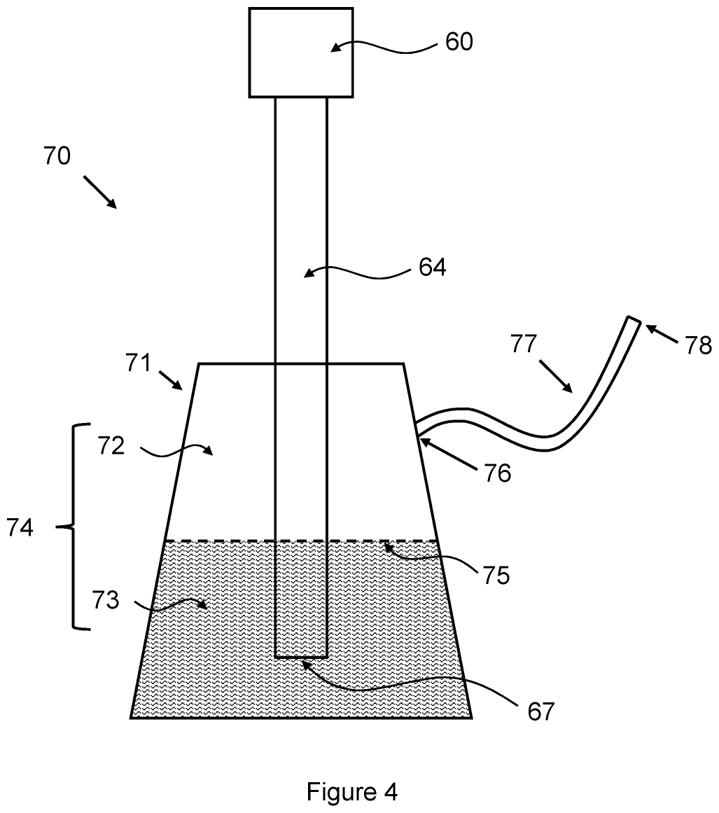

FIG. 4 is a schematic illustration of a shisha device according to an embodiment of this disclosure;

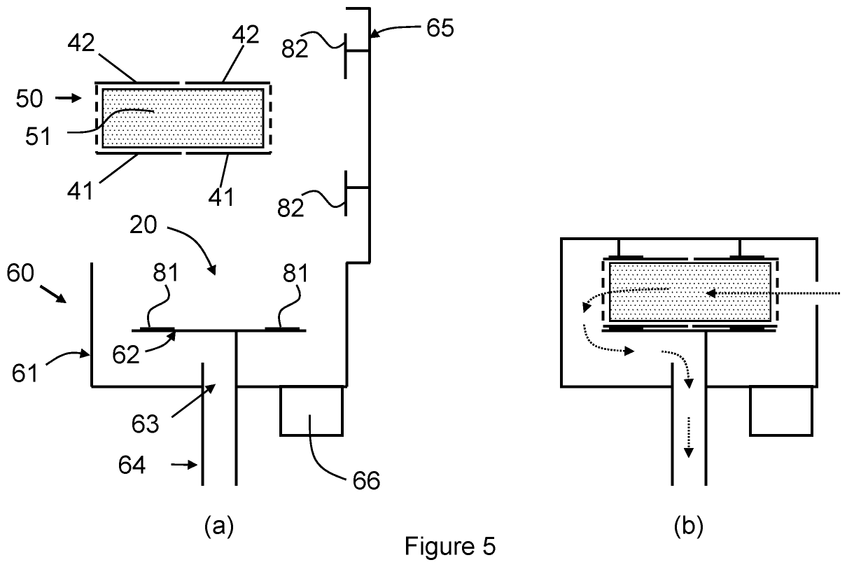

FIG. 5 is a schematic illustration of a heating unit of a shisha device and an aerosol-generating article comprising a plurality of pairs of electrodes according to an embodiment of the disclosure;

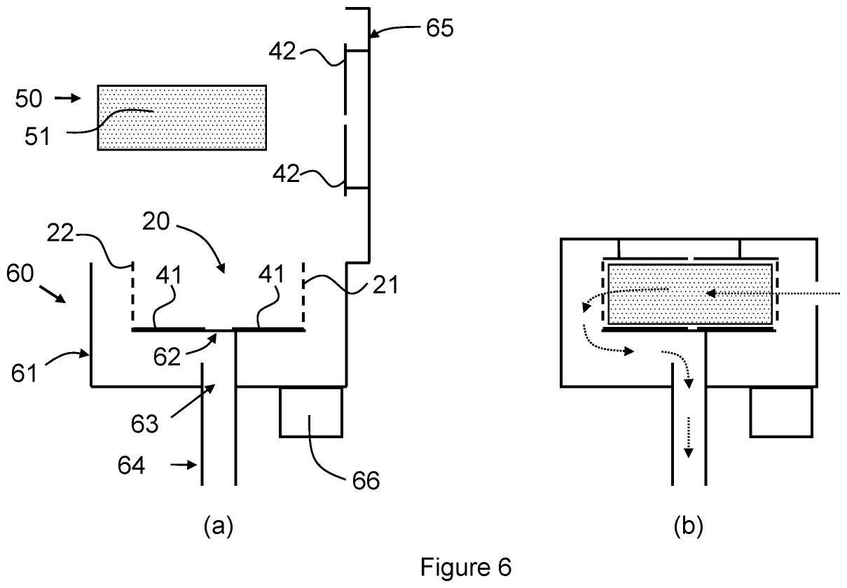

FIG. 6 is a schematic illustration of a heating unit of a shisha device comprising a plurality of pairs of electrodes and an aerosol-generating article according to an embodiment of the disclosure; and

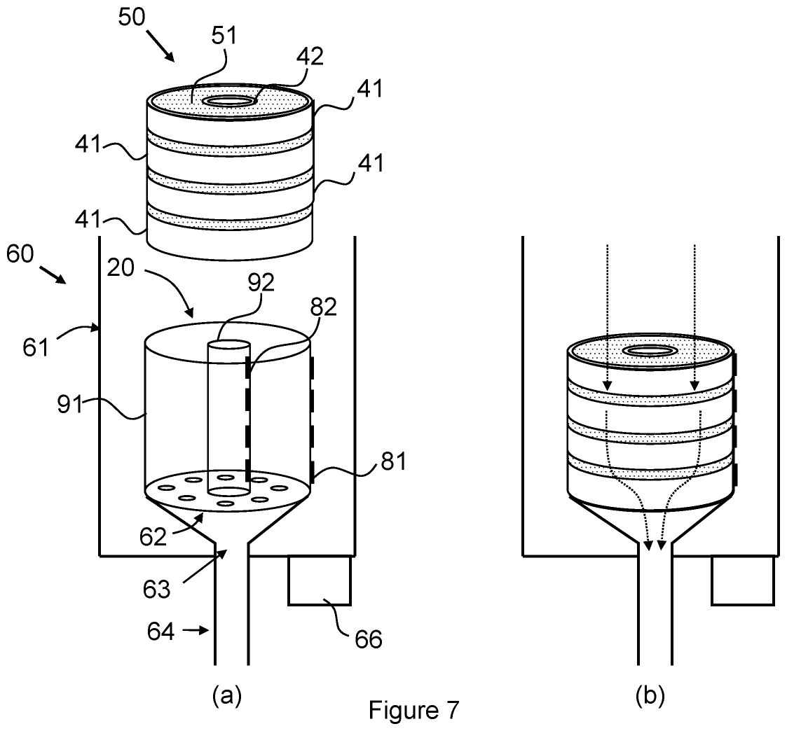

FIG. 7 is a schematic illustration of a heating unit of a shisha device and an aerosol-generating article comprising a plurality of pairs of electrodes according to an embodiment of the disclosure.

FIG. 1 is a schematic illustration of a system for dielectrically heating an aerosol-forming substrate using radio frequency (RF) electromagnetic radiation according to an embodiment of the present disclosure. The system comprises an oscillation circuit 10 including a radio frequency (RF) signal generator 11 and a phase shift network 12, and a plurality of pairs of electrodes. The oscillation circuit 10 is controlled by a controller (not shown). Each pair of electrodes comprises a first electrode 41 spaced apart from a second electrode 42. The first electrode 41 of each pair of electrodes is connected to a first output of the phase shift network 12, and the second electrode 42 of each pair of electrodes is connected to a second output of the phase shift network 12. An aerosol-generating article 50 comprising an aerosol-forming substrate 51 is disposed between the two pairs of electrodes, with each pair of electrodes forming a capacitor with a portion of the aerosol-forming substrate 51. The aerosol-forming substrate 51 acts as the dielectric of the capacitors. The oscillation circuit 10 supplies an alternating voltage to each of the first electrodes 41 and the second electrodes 42, which generates an alternating electromagnetic field between the first electrodes 41, and the second electrodes 42. Polar molecules within the aerosol-generating article 50 align with the oscillating electromagnetic field and so are agitated by the electromagnetic field as it oscillates. This causes an increase in temperature of the aerosol-generating article 50. This kind of heating has the advantage that it is uniform throughout the aerosol-generating article 50 (provided that the polar molecules are uniformly distributed). It also has the advantage of reducing the likelihood of combustion of the substrate in contact with the first electrode and the second electrode compared to a conventional heating element that transfers heat to the substrate via conduction.

In this embodiment, the plurality of pairs of electrodes comprises two pairs of electrodes. However, it will be appreciated that in other embodiments, the system may comprise more than two pairs of electrodes.

FIG. 2 is a schematic illustration of another system for dielectrically heating an aerosol-forming substrate according to an embodiment of the present disclosure. The system illustrated in FIG. 2 is similar to the system illustrated in FIG. 1, and like features are denoted by like reference numerals. The system illustrated in FIG. 2 differs from the system in FIG. 1 in that the system in FIG. 2 further comprises a controller 13 and relay-switch circuits 30. A relay-switch circuit 30 is provided for each pair of electrodes 41, 42. For each relay-switch circuit 30, the controller 13 is configured to energise a relay 31 in order to operate a switch 32 so as to control the supply of the alternating voltage to one of the pairs of electrodes. In this way, the controller can selectively supply the alternating voltage to one of the pairs of electrodes in order to heat a selected portion of the aerosol-forming substrate 51, without heating the entire aerosol-forming substrate 51.

FIGS. 3a and 3b are schematic illustrations of a planar aerosol-generating article according to an embodiment of this disclosure. FIG. 3a shows a perspective view of the aerosol-generating article 50. FIG. 3b shows a cross-sectional view of the aerosol-generating article 50. The aerosol-generating article 50 comprises four pairs of electrodes, each pair of electrodes comprising a first electrode 41 and a second electrode 42. An aerosol-forming substrate 51 is disposed between the pairs of electrodes. The first electrode 41 of each pair of electrodes is substantially planar and extends substantially in a first plane. The second electrode 42 of each pair of electrodes is substantially planar and extends substantially in a second plane. The first plane is substantially parallel to the second plane. In this embodiment, the aerosol-generating article has a rectangular cross-sectional shape, with the aerosol-forming substrate 51 and each of the electrodes 41, 42 also having a rectangular cross-sectional shape. It will be appreciated that in other embodiments the aerosol-generating article, aerosol-forming substrate, and electrodes may have another cross-sectional shape other than that illustrated in FIGS. 3a and 3b.

FIGS. 3c and 3d are schematic illustrations of a cylindrical aerosol-generating article 50 according to another embodiment of this disclosure. FIG. 3c shows a perspective view of the aerosol-generating article 50. FIG. 3d shows a cross-sectional view of the aerosol-generating article 50. The aerosol-generating article 50 comprises four pairs of electrodes, each pair of electrodes comprising a first electrode 41 and a second electrode 42. The first electrode 41 of each pair of electrodes circumscribes the second electrode 42 of the pair of electrodes. The first electrode 41 of each pair of electrodes is substantially coaxial with the second electrode 42 of the pair of electrodes. The first electrode 41 of each pair of electrodes is substantially annular, and defines an internal passage. The second electrode 42 of each pair of electrodes is substantially cylindrical, and is disposed in the internal passage of the first electrode 41 of the pair of electrodes. An aerosol-forming substrate 51 is disposed between the pairs of electrodes.

FIG. 4 is a schematic illustration of a shisha system according to an embodiment of this disclosure. The principles of this disclosure are applicable to dielectrically heated aerosol-generating systems in general, however, a shisha system has been chosen for illustrative purposes.

The shisha device 70 comprises a vessel 71 defining a liquid cavity 74. The vessel 71 is configured to retain a volume of liquid in the liquid cavity 74, and is formed from a rigid, optically transparent material, such as glass. In this embodiment, the vessel 71 has a substantially frustoconical shape, and is supported in use at its wide end on a flat, horizontal surface, such as a table or shelf. The liquid cavity 74 is divided into two sections, a liquid section 73 for receiving a volume of liquid, and a headspace 72 above the liquid section 73. A liquid fill level 75 is positioned at the boundary between the liquid section 73 and the headspace 72, the liquid fill level 75 being demarcated on the vessel 71 by a dashed line marked on an outer surface of the vessel 71. A headspace outlet 76 is provided on a side wall of the vessel 71, above the liquid fill level 75. The headspace outlet 76 enables fluid to be drawn out of the liquid cavity 74 from the headspace 72. A mouthpiece 78 is connected to the headspace outlet 76 by a flexible hose 77. A user may draw on the mouthpiece 78 to draw fluid out of the headspace 72 for inhalation.

The shisha device 70 further comprises a heating unit 60 comprising an oscillator circuit in accordance with the present disclosure. Examples of different heating units will be discussed in more detail below with reference to FIGS. 3 and 4. The heating unit 60 is arranged above the vessel 71 by an airflow conduit 64. In this embodiment, the heating unit 60 is supported above the vessel 71 by the airflow conduit 64, however, it will be appreciated that in other embodiments the heating unit 60 may be supported above the vessel 71 by a housing of the shisha device or another suitable support. The airflow conduit 64 extends from the heating unit 60 into the liquid cavity 74 of the vessel 71. The airflow conduit 64 extends through the headspace 72, and below the liquid fill level 75 into the liquid section 73. The airflow conduit 64 comprises an outlet 67 in the liquid section 73 of the liquid cavity 74, below the liquid fill level 75. This arrangement enables air to be drawn from the heating unit 60 to the mouthpiece 78. Air may be drawn from an environment external to the device 70, into the heating unit 60, through the heating unit 60, though the airflow conduit 64 into the volume of liquid in the liquid section 73 of the liquid cavity 74, out of the volume of liquid into the headspace 72, and out of the vessel from the headspace 72 at the headspace outlet 76, through the hose 77 and to the mouthpiece 78.

In use, a user may draw on the mouthpiece 78 of the shisha device 70 to receive aerosol from the shisha device 70. In more detail, an aerosol-generating article comprising an aerosol-forming substrate can be positioned in an article cavity within the heating unit 60 of the shisha device 60, for example, the aerosol-generating articles 50 of FIG. 2. The heating unit 70 may be operated to heat the aerosol-forming substrate within the aerosol-generating article and release volatile compounds from the heated aerosol-forming substrate. When a user draws on the mouthpiece 78 of the shisha device 70, the pressure within the shisha device 70 is lowered, which draws the released volatile compounds from the aerosol-forming substrate out of the heating unit 60 and into the airflow conduit 64. The volatile compounds are drawn out of the airflow conduit 64 at the outlet 67, into the volume of liquid in the liquid section 73 of the liquid cavity 74. The volatile compounds cool in the volume of liquid and are released into the headspace 72 above the liquid fill level 75. The volatile compounds in the headspace 72 condense to form an aerosol that is drawn out of the headspace at the headspace outlet 76 and to the mouthpiece 78 for inhalation by the user.

FIG. 5 shows schematic illustrations of a heating unit 60 for the shisha device 70 of FIG. 4, in combination with the planar aerosol-generating article 50 of FIGS. 3a and 3b, forming a shisha system according to an embodiment of this disclosure. FIG. 5a shows the heating unit 60 and the aerosol-generating article 50 before insertion of the aerosol-generating article 50 into an article cavity 20 of the heating unit 60. FIG. 5b shows the aerosol-generating article 50 received in the article cavity 20 of the heating unit 60.

As shown in FIG. 5a, the heating unit 60 comprises an external housing 61. The external housing 61 forms a cylindrical tube that is open at one end for insertion of the aerosol-generating article 50, and is substantially closed at the opposite end. In this embodiment, the external housing 61 is formed from a material that is opaque to RF electromagnetic radiation, such as aluminium. However, it will be appreciated that the housing 61 does not need to be formed from a material that is opaque to RF electromagnetic radiation, but rather in some embodiments may be formed from a material that is substantially transparent to RF electromagnetic radiation, such as a ceramic material or a plastic material.

A closure 65 is moveable over the open end of the external housing 61 of the heating unit 60 to substantially close the open end. In this position, the external housing 61 and the closure 65 define a heating unit cavity. The closure 65 comprises an external housing similar to the external housing 61 of the heating unit, formed from the same material opaque to the RF electromagnetic field and sized and shaped to align and engage with the external housing 61 to close the open end. The closure 65 is rotatably connected to the external housing 61 by a hinge, and is rotatable between an open position, as shown in FIG. 5a, and a closed position, as shown in FIG. 5b. When the closure 65 is in the open position, the open end of the external housing 61 is open for insertion of an aerosol-generating article 50 into the heating unit cavity, and for removal of the aerosol-generating article 50 from the heating unit cavity. When the closure 65 is in the closed position, the heating unit cavity is surrounded by material that is opaque to a RF electromagnetic field, such that a RF electromagnetic field is unable to propagate from the heating unit cavity.

A side wall of the external housing 61 comprises an air inlet (shown in FIG. 5b), for enabling ingress of ambient air into the heating unit cavity.

The heating unit 60 is arranged above the vessel 71 of the shisha device 70 on the airflow conduit 64. The airflow conduit 64 extends into the heating unit cavity and is fixedly attached to the substantially closed end of the external housing 61 of the heating unit 60. It will be appreciated that in other embodiments, the heating unit 60 may be removably attached to the airflow conduit 64, such that the heating unit 60 may be removed for cleaning or replacement if necessary. In this embodiment, the heating unit 70 comprises a plurality of first electrical contacts 81 and a plurality of second electrical contacts 82. The first electrical contacts 81 are secured to a base 62 supported in the external housing 61. The second electrical contacts 82 are secured to an inner surface of the closure 65. In this embodiment, the article cavity is merely defined by the base 62. The first electrical contacts 81 and the second electrical contacts 82 are substantially identical, and comprise circular sheets of metal with a diameter that is significantly smaller than the diameter of the aerosol-generating article 50.

The heating unit 60 further comprises circuitry 66 which comprises the oscillation circuit 10. In some embodiments, the circuitry 66 may also comprise the controller 13 and the relay-switch circuits 30. The control circuitry 66 is connected to a power supply (not shown) of the shisha device. In this embodiment, the power supply is a rechargeable lithium-ion battery, and the shisha device 70 comprises a power connector that enables the shisha device 70 to be connected to a mains power supply for recharging the power supply. Providing the shisha device 70 with a power supply, such as a battery, enables the shisha device 70 to be portable and used outdoors or in locations in which a mains power supply is not available. The first electrical contacts 81 and the second electrical contacts 81 are electrically connected to the control circuitry 66.

As shown in FIG. 5b, when the aerosol-generating article 50 is received in the article cavity 80 of the heating unit 60, and the closure 65 is arranged in the closed position, the first electrodes 41 of the aerosol-generating article 50 contact the plurality of first electrical contacts 81 and the second electrodes 42 contact the plurality of second electrical contacts 82 of the heating unit 60. In this arrangement, a plurality of capacitors is formed by the plurality of pairs of electrodes.

When a user draws on the mouthpiece 78 of the shisha device 70, air is drawn into the shisha device 70 through the air inlet of the external housing 61. An airflow path through the aerosol-generating article 50 and heating unit 60 is shown by the arrows in FIG. 4b. Air is drawn into the heating unit cavity through the air inlet of the external housing 61, and from the heating unit cavity into the aerosol-generating article 50. Air is drawn through the aerosol-forming substrate 51 into the airflow conduit 64 through the opening 63 in the external housing 61 of the heating unit 60.

In use, power is supplied to the circuitry 66 from the power supply when a user activates the shisha device 70. In this embodiment, the shisha device is activated by a user pressing an activation button (not shown) provided on an external surface of the heating unit 60. It will be appreciated that in other embodiments, the shisha device may be activated in another manner, such as on detection of a user drawing on the mouthpiece 78 by a puff sensor provided on the mouthpiece 78. When power is supplied to the oscillation circuit 10, the oscillation circuit generates two substantially equal, out of phase RF electromagnetic signals with a frequency of between 20 KHz and 300 MHz. One of the signals is supplied to the first electrode 41 of each pair of electrodes, and the other signal is supplied to the second electrode 42 of each pair of electrodes. The RF electromagnetic signals supplied to the first electrode 41 and the second electrode 42 of each pair of electrodes establishes an alternating RF electromagnetic field in the article cavity 20, which dielectrically heats the aerosol-forming substrate 51, which releases volatile compounds.

FIG. 6 shows a heating unit 60 for a shisha device and an aerosol-generating article 50, forming a shisha system according to another embodiment of this disclosure. The heating unit 60 and aerosol-generating article 50 shown in FIG. 60 are substantially similar to the heating unit 60 and aerosol-generating article 50 shown in FIG. 5, and like reference numerals are used to represent like features. FIG. 6a shows the heating unit 60 and the aerosol-generating article 50 before insertion of the aerosol-generating article 50 into an article cavity 20 of the heating unit 60. FIG. 6b shows the aerosol-generating article 50 received in the article cavity 20 of the heating unit 60.

The heating unit 60 shown in FIG. 6 differs from the heating unit 60 shown in FIG. 5 in that the heating unit 60 of FIG. 6 comprises the first electrode 41 and the second electrode 42 of each pair of electrodes, instead of the aerosol-generating article 50 comprising the first electrode 41 and the second electrode 42 of each pair of electrodes as in the embodiment of FIG. 5. In this embodiment, the article cavity is defined by base 62, a first wall 21 and a second wall 22. The first wall 21 and the second wall 22 are connected and are disposed around the perimeter of the base 62.

FIG. 7 shows schematic illustrations of a heating unit 60 of the shisha device 70 of FIG. 4 in combination with the aerosol-generating article 50 of FIGS. 3c and 3d, forming a shisha system according to another embodiment of this disclosure. The heating unit 60 shown in FIG. 5 is substantially similar to the heating unit 60 and like reference numerals are used to represent like features. FIG. 7a shows the heating unit 60 and the aerosol-generating article 50 before insertion of the aerosol-generating article 50 into an article cavity 20 of the heating unit 60. FIG. 7b shows the aerosol-generating article 50 received in the article cavity 20 of the heating unit 60.

As shown in FIG. 7a, the article cavity 20 has a substantially annular cylindrical shape defined by a curved surface 91. A column 92 extends into the article cavity 20 from the base 62, coaxially with the cavity 20, and is circumscribed by the curved surface 91. In this embodiment, the heating unit 60 comprises a plurality of first electrical contact pads 81 on the curved surface 91 defining the cavity 20, and a plurality of second electrical contact pads 82 on the outer surface of the column 92 in the article cavity 20. Similarly to FIG. 5, the first electrical contact pad 81 and the second electrical contact pad 82 are electrically connected to the circuitry 66

In this embodiment, the article 50 has a cylindrical, annular shape, defining an internal passage. The article 50 comprises an annular body of aerosol-forming substrate 51, wrapped in cigarette paper (not shown). The curved outer surface of the article 50 is complementary to the curved surface 91 defining the article cavity 20. The inner passage of the article 50 is also complementary to the column 92 in the article cavity 20. As such, the aerosol-generating article 50 closely fits inside the article cavity 20, with the column 92 received in the inner passage of the article 50. A plurality of first electrodes 41 are disposed on the curved outer surface of the article 50. The plurality of first electrodes 41 are arranged complementary to the plurality of first electrical contacts 81 in the article cavity 20, such that the first electrodes 41 physically contact the first electrical contacts 81 when the aerosol-generating article 50 is received in the article cavity 20. A plurality of second electrodes 42 are disposed on the inner surface of the internal passage of the article 50. The plurality of second electrodes 42 are arranged complementary to the plurality of second electrical contacts 82 in the article cavity 20, such that the second electrodes 42 physically contact the second electrical contacts 82 when the aerosol-generating article 50 is received in the article cavity 20.

As shown in FIG. 7b, when the aerosol-generating article 50 is received in the article cavity 20 of the heating unit 60, the first electrodes 41 of the aerosol-generating article 50 contact the plurality of first electrical contacts 81 and the second electrodes 42 contact the plurality of second electrical contacts 82 of the heating unit 60. In use, air is drawn through the aerosol-generating substrate 51 of the aerosol-generating article 50 along the length of the aerosol-generating article, as shown in FIG. 7b.

It will be appreciated that the embodiments described above are exemplary embodiments only, and various other embodiments according with this disclosure are also envisaged.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±5% of A.

1.-15. (canceled)

16. A dielectrically heatable aerosol-generating system, comprising:
an aerosol-forming substrate;
a plurality of pairs of electrodes, each pair of electrodes comprising a first electrode spaced apart from a second electrode; and
an aerosol-generating device comprising a controller configured to connect to said each pair of electrodes,
wherein said each pair of electrodes forms a capacitor with a portion of the aerosol-forming substrate, and
wherein the controller is further configured to supply an alternating voltage to the plurality of pairs of electrodes for dielectrically heating the aerosol-forming substrate.

17. The aerosol-generating system according to claim 16, wherein the controller is further configured to selectively control the supply of the alternating voltage to said each pair of electrodes for dielectrically heating the aerosol-forming substrate.

18. The aerosol-generating system according to claim 17, wherein the controller is further configured to selectively supply the alternating voltage to said each pair of electrodes in a sequence.

19. The aerosol-generating system according to claim 18, wherein the controller is further configured to determine a sequence of supply of the alternating voltage to said each pair of electrodes.

20. The aerosol-generating system according to claim 19, wherein the sequence is determined based on at least one of: a temperature of one or more of the plurality of pairs of electrodes, a temperature of a portion of the aerosol-forming substrate, a temperature adjacent to the aerosol-forming substrate, an activation of a puff sensor, and a duration of supply of the alternating voltage to one or more of the plurality of pairs of electrodes.

21. The aerosol-generating system according to claim 16,
wherein the controller is further configured to monitor which of the plurality of pairs of electrodes has received the supply of the alternating voltage for dielectrically heating the aerosol-forming substrate, and
wherein the controller further comprises a memory configured to store which of the plurality of pairs of electrodes has received the supply of the alternating voltage.

22. The aerosol-generating system according to claim 16, wherein the plurality of pairs of electrodes comprises between 2 and 15 pairs of electrodes.

23. The aerosol-generating system according to claim 16, wherein the plurality of pairs of electrodes comprises between 5 and 12 pairs of electrodes.

24. The aerosol-generating system according to claim 16,
wherein the first electrodes of the plurality of pairs of electrodes form a first array of electrodes, each electrode in the first array of electrodes being spaced apart by an electrode spacing distance, and
wherein the second electrodes of the plurality of pairs of electrodes form a second array of electrodes, each electrode in the second array of electrodes being spaced apart by the electrode spacing distance.

25. The aerosol-generating system according to claim 24,
wherein the first electrodes of the first array of electrodes are substantially tessellated, and
wherein the second electrodes of the second array of electrodes are substantially tessellated.

26. The aerosol-generating system according to claim 16, wherein the first electrode of said each pair of electrodes is planar, extending substantially in a first plane, and the second electrode of said each pair of electrodes is planar, extending substantially in a second plane.

27. The aerosol-generating system according to claim 26, wherein the first plane is substantially parallel to the second plane.

28. The aerosol-generating system according to claim 16, wherein the first electrode of said each pair of electrodes circumscribes the second electrode of the pair of electrodes.

29. The aerosol-generating system according to claim 28,
wherein the first electrode of said each pair of electrodes is annular, defining an internal passage, and
wherein the second electrode of said each pair of electrodes is disposed in the internal passage of the first electrode.

30. The aerosol-generating system according to claim 16, wherein the aerosol-generating device further comprises the plurality of pairs of electrodes.

31. The aerosol-generating system according to claim 16, further comprising an aerosol-generating article, the aerosol-generating article comprising the aerosol-forming substrate and at least one electrode of the plurality of pairs of electrodes.

32. The aerosol-generating system according to claim 16, wherein the aerosol-generating system is a shisha system, with the aerosol-generating device being a shisha device, the shisha device comprising:
a liquid cavity configured to contain a volume of liquid through which aerosol generated by the shisha device is drawn before inhalation by a user, the liquid cavity having a head space outlet, and
an article cavity configured to receive the aerosol-forming substrate, the article cavity being in fluid communication with the liquid cavity.

33. An aerosol-generating article for a dielectrically heatable aerosol-generating system, the aerosol-generating article comprising:
an aerosol-forming substrate; and
a plurality of pairs of electrodes, each pair of electrodes comprising a first electrode spaced apart from a second electrode,
wherein said each pair of electrodes forms a capacitor with at least a portion of the aerosol-forming substrate.
